(19) United States
(12) Patent Application Publication
(10) Pub. No.: US 2023/0388886 A1
(43) Pub. Date: Nov. 30, 2023

(54) Network System and Terminal Device

(71) Applicant: Huawei Technologies Co., Ltd., Shenzhen (CN)

(72) Inventor: Wei Huang, Shanghai (CN)

(21) Appl. No.: 18/027,616

(22) PCT Filed: Aug. 4, 2021
(86) PCT No.: PCT/CN2021/110454

§ 371 Date: Mar. 21, 2023

(30) Foreign Application Priority Data
Sep. 23, 2020 (CN) 202011008892.1

(51) Int. Cl. H04W 36/30; H04W 36/00; H04W 36/14; H04W 72/0453; H04L 65/1016

(52) U.S. Cl. CPC H04W 36/30; H04W 36/0058; H04W 36/144; H04W 72/0453; H04L 65/1016; H04W 36/0088

(57) ABSTRACT

A network system and a terminal device are provided. The network system includes a 5G access network NG-RAN and a terminal device UE that camps on the NG-RAN. The UE is configured to measure a long term evolution LTE cell when initiating an IP multimedia subsystem IMS voice call request or receiving an IMS voice call request. The NG-RAN is configured to determine, according to configuration of the NG-RAN, whether to enable IMS voice to fall back to a 4G network from a 5G network, and to send a measurement request message to the UE when determining fallback of the IMS voice to the 4G network. The UE is further configured to: in response to the measurement request message, report to the NG-RAN a measurement report based on a measurement result of the LTE cell measurement.

### CROSS-REFERENCE TO RELATED APPLICATIONS

This application is a national stage of International Application No. PCT/CN2021/110454, filed on Aug. 4, 2021, which claims priority to Chinese Patent Application No. 202011008892.1, filed on Sep. 23, 2020. Both of the aforementioned applications are hereby incorporated by reference in their entireties.

### TECHNICAL FIELD

This application relates to the field of communication technologies, and in particular, to a network system and a terminal device.

### BACKGROUND

The 5th generation mobile communication network (English: 5th generation mobile network, 5G) is a latest generation of mobile communication technology. Compared with early mobile communication technologies such as 4G, 3G, and 2G, 5G is capable of providing a higher data rate, a lower latency, and a fully connected Internet of things, is more energy saving, has lower costs and a higher system capacity, and supports massive connected devices.

Currently, as specified in 3GPP, 5G standalone (5G SA) uses a voice architecture of a 4G mobile communication network and still provides a voice service based on an IP multimedia subsystem (IP multimedia subsystem, IMS). A radio access technology of the 4G mobile communication network is long term evolution (long term evolution, LTE), and a voice call service carried over the 4G mobile communication network is called Volte. A radio access technology of the 5G mobile communication network is new radio (new radio, NR), and a voice call service carried over the 5G mobile communication network is called Voong. VoNR will be a final solution for a voice service on 5G SA. In the early stage of 5G SA construction, 5G NR is not capable of providing the voice service. In this case, the voice service need to be implemented based on VoLTE. That is, when UE camping on NR initiates a call, fallback to 4G is performed by using EPS FB (EPS Fallback), and the voice service is carried by using VoLTE. When the EPS FB is triggered, a network side can request the UE to perform LTE cell measurement, and determine, based on a measurement report reported by the UE, how fallback to 4G is performed. In this period, the network side needs to spend time waiting for the UE to report the measurement report, which prolongs a waiting time for setup of an EPS FB call. User experience is degraded.

### SUMMARY

Embodiments of this application provide a network system and a terminal device to shorten a waiting time for setup of an EPS FB call, and improve user experience.

According to a first aspect, an embodiment of this application provides a network system. The network system includes an access network device and user equipment UE. The UE is configured to perform long term evolution LTE cell measurement when initiating an IP multimedia subsystem IMS voice call request or receiving an IMS voice call request. The access network device is configured to send a measurement request message to the UE when determining whether to enable IMS voice to fall back from a 5G network to a 4G network. The measurement request message is used for measuring an LTE cell. The UE is further configured to, in response to the measurement request message, report a measurement report to an NG-RAN based on a measurement result of the LTE cell, so that the UE camps on the 4G network.

In this way, the UE has performed cell measurement before receiving the measurement request message. Therefore, when receiving the measurement request message from the access network device, the UE can report the measurement report to the access network device earlier based on the measurement result of the LTE cell measurement that has been completed in advance. Time for the access network device to wait for the UE to report the measurement report is shortened, and an objective of shortening a waiting time for the setup of the EPS FB call is achieved.

In an implementation, the UE is specifically configured to determine, based on information such as historical LTE frequency information, information about a new radio NR cell on which the UE currently camps, and/or a hardware capability of the UE, at least one first target frequency that is used for no-gap (no-gap) measurement. The UE is further configured to measure the LTE cell on the first target frequency. In this way, when performing the LTE cell measurement, the UE can continue to perform data communication with a network side network element like the access network device. A failure to receive a message from a network side is prevented from causing an IMS call setup failure.

In an implementation, the UE is specifically configured to select, from historical LTE frequencies based on a hardware capability of the UE, all frequencies on which no-gap measurement can be performed to serve as first target frequencies.

In an implementation, the UE is specifically configured to select, from the historical LTE frequencies based on the hardware capability of the UE, all frequencies on which the no-gap measurement can be performed, and to determine whether a quantity of all the frequencies on which the no-gap measurement can be performed is greater than a preset maximum quantity. When the quantity of all the frequencies on which the no-gap measurement can be performed is greater than the maximum quantity, the UE is further configured to select, from all the frequencies on which the no-gap measurement can be performed, frequencies whose quantity is less than or equal to the maximum quantity to serve as the first target frequencies. When the quantity of all the frequencies on which the no-gap measurement can be performed is less than or equal to the maximum quantity, the UE is further configured to use all the frequencies on which the no-gap measurement can be performed as the first target frequencies.

In an implementation, the UE is specifically configured to select, from the historical LTE frequencies based on the hardware capability of the UE, all frequencies on which the no-gap measurement can be performed, and to determine, based on a preset validity period, a first target frequency from all the frequencies on which the no-gap measurement can be performed. A time interval between a time at which the UE leaves the first target frequency for the last time and a current time is less than or equal to the validity period.

In an implementation, the UE is specifically configured to select, from the historical LTE frequencies based on the hardware capability of the UE, all frequencies on which the no-gap measurement can be performed, and to determine, based on a preset distance threshold, a first target frequency from all the frequencies on which the no-gap measurement can be performed. A distance between a location of an LTE cell corresponding to the first target frequency and a current location of the UE is less than or equal to the distance threshold.

In an implementation, the UE is specifically configured to determine the current location based on satellite positioning information, wireless fidelity Wi-Fi information, base station positioning information, and/or a currently accessed NR cell.

In an implementation, the UE is further configured to determine, based on an ascending order of time intervals between times at which the UE leaves the first target frequencies for the last time and a current time, a sequence of the first target frequencies on which the LTE cell is measured.

In an implementation, the UE is further configured to determine camping duration of the UE at each first target frequency, and to determine, based on a descending order of camping duration, a sequence of the first target frequencies on which the LTE cell is measured.

In an implementation, the UE is further configured to determine, based on an ascending order of distances between locations of the LTE cell corresponding to the first target frequencies and a current location of the UE, a sequence of the first target frequencies on which the LTE cell is measured.

In an implementation, the measurement request message includes at least one second target frequency. The UE is configured to, in response to the measurement request message, obtain an intersection of second target frequencies and a frequency on which the measurement has been completed in the first target frequencies, to determine a frequency on which the measurement has not been completed in the second target frequencies. The UE is further configured to measure the LTE cell on the frequency on which the measurement has not been completed in the second target frequencies. In this way, when receiving the measurement request message from the access network device, the UE can perform the cell measurement only on the frequency on which the measurement has not been completed in the second target frequencies. Therefore, a measurement time is shortened, and the time for the access network device to wait for the UE to report the measurement report is thus shortened. The objective of shortening a waiting time for the setup of the EPS FB call is finally achieved.

In an implementation, the measurement request message includes a measurement evaluation time. The UE is configured to determine, in response to the measurement request message, whether the measurement result meets a reporting condition for the measurement report. The UE is further configured to use a time at which the measurement request message is received as a start time of the measurement evaluation time if the reporting condition for the measurement report is met. The UE is further configured to wait for a time at which the reporting condition for the measurement report is met if the reporting condition for the measurement report fails to be met, and to use the time at which the reporting condition for the measurement report is met as the start time. In this way, if the measurement report meets the reporting condition when the UE receives the measurement request message, the UE can use the time at which the UE receives the measurement request message as a start time for calculating the measurement evaluation time. Therefore, the UE can finish waiting earlier and report the measurement report to the access network device. The time for the access network device to wait for the UE to report the measurement report is shortened, and the objective of shortening the waiting time for the setup of the EPS FB call is achieved.

In an implementation, the UE is further configured to, if the measurement result constantly meets the reporting condition for the measurement report within the measurement evaluation time, report the measurement report to the access network device after the measurement evaluation time ends.

In an implementation, the UE is specifically configured to, when the UE is configured to support the fallback of the IMS voice from the 5G network to the 4G network, determine whether to fall back to the 4G network based on a capability of the UE, an indication of an access and mobility management function AMF network element of a core network, network configuration, and/or a radio condition.

In an implementation, the access network device is a 5G access network NG-RAN.

According to a second aspect, an embodiment of this application provides a terminal device UE, including a transceiver, a memory, and a processor. The memory stores computer program instructions. When the program instructions are executed by the processor, the terminal device is enabled to implement the following method steps: when an IP multimedia subsystem IMS voice call request is initiated or an IMS voice call request is received, measuring a long term evolution LTE cell; receiving a measurement request message sent by an access network device, where the measurement request message is sent when the access network device determines to enable IMS voice to fall back from a 5G network to a 4G network, and the measurement request message is used for measuring the LTE cell; and in response to the measurement request message, reporting a measurement report to the access network device based on a measurement result of the LTE cell, so that the UE camps on the 4G network.

In this way, the UE has performed cell measurement before receiving the measurement request message. Therefore, when receiving the measurement request message from the access network device, the UE can report the measurement report to the access network device earlier based on the measurement result of the LTE cell measurement that has been completed in advance. Time for the access network device to wait for the UE to report the measurement report is shortened, and an objective of shortening a waiting time for the setup of the EPS FB call is achieved.

In an implementation, when the program instructions are executed by the processor, the terminal device is enabled to specifically implement the following method steps: determining, based on information such as historical LTE frequency information, information about a new radio NR cell on which the terminal device currently camps, and/or a hardware capability of the UE, at least one first target frequency that is used for no-gap (no-gap) measurement; and measuring the LTE cell on the first target frequency. In this way, when performing the LTE cell measurement, the UE can continue to perform data communication with a network side network element like the access network device. A failure to receive a message from a network side is prevented from causing an IMS call setup failure.

In an implementation, when the program instructions are executed by the processor, the terminal device is enabled to specifically implement the following method step: selecting, from historical LTE frequencies based on the hardware capability of the UE, all frequencies on which no-gap measurement can be performed to serve as first target frequencies.

In an implementation, when the program instructions are executed by the processor, the terminal device is enabled to specifically implement the following method steps: selecting, from historical LTE frequencies based on the hardware capability of the UE, all frequencies on which the no-gap measurement can be performed; determining whether a quantity of all the frequencies on which the no-gap measurement can be performed is greater than a preset maximum quantity; when the quantity of all the frequencies on which the no-gap measurement can be performed is greater than the maximum quantity, selecting, from all the frequencies on which the no-gap measurement can be performed, frequencies whose quantity is less than or equal to the maximum quantity to serve as the first target frequencies; and when the quantity of all the frequencies on which the no-gap measurement can be performed is less than or equal to the maximum quantity, using all the frequencies on which the no-gap measurement can be performed as the first target frequencies.

In an implementation, when the program instructions are executed by the processor, the terminal device is enabled to specifically implement the following method steps: selecting, from the historical LTE frequencies based on the hardware capability of the UE, all frequencies on which the no-gap measurement can be performed; and determining, based on a preset validity period, a first target frequency from all the frequencies on which the no-gap measurement can be performed. A time interval between a time at which the UE leaves the first target frequency for the last time and a current time is less than or equal to the validity period.

In an implementation, when the program instructions are executed by the processor, the terminal device is enabled to specifically implement the following method steps: selecting, from historical LTE frequencies based on the hardware capability of the UE, all frequencies on which the no-gap measurement can be performed; and determining, based on a preset distance threshold, a first target frequency from all the frequencies on which the no-gap measurement can be performed. A distance between a location of an LTE cell corresponding to the first target frequency and a current location of the UE is less than or equal to the distance threshold.

In an implementation, when the program instructions are executed by the processor, the terminal device is enabled to specifically implement the following method step: determining the current location based on satellite positioning information, wireless fidelity Wi-Fi information, base station positioning information, and/or a currently accessed NR cell.

In an implementation, when the program instructions are executed by the processor, the terminal device is further enabled to implement the following method step: determining, based on an ascending order of time intervals between times at which the terminal device leaves the first target frequencies for the last time and a current time, a sequence of the first target frequencies on which the LTE cell is measured.

In an implementation, when the program instructions are executed by the processor, the terminal device is further enabled to implement the following method steps: determining camping duration of the terminal device at each first target frequency; and determining, based on a descending order of camping duration, a sequence of the first target frequencies on which the LTE cell is measured.

In an implementation, when the program instructions are executed by the processor, the terminal device is further enabled to implement the following method step: determining, based on an ascending order of distances between locations of the LTE cell corresponding to the first target frequencies and a current location of the terminal device, a sequence of the first target frequencies on which the LTE cell is measured.

In an implementation, the measurement request message includes at least one second target frequency. When the program instructions are executed by the processor, the terminal device is further enabled to implement the following method steps: in response to the measurement request message, obtaining an intersection of second target frequencies and a frequency on which the measurement has been completed in the first target frequencies, to determine a frequency on which the measurement has not been completed in the second target frequencies; and measuring the LTE cell on the frequency on which the measurement has not been completed in the second target frequencies. In this way, when receiving the measurement request message from the access network device, the UE can perform the cell measurement only on the frequency on which the measurement has not been completed in the second target frequencies. Therefore, a measurement time is shortened, and the time for the access network device to wait for the UE to report the measurement report is thus shortened. The objective of shortening a waiting time for the setup of the EPS FB call is finally achieved.

In an implementation, the measurement request message includes a measurement evaluation time. When the program instructions are executed by the processor, the terminal device is further enabled to implement the following method steps: determining, in response to the measurement request message, whether the measurement result meets a reporting condition for the measurement report; using a time at which the measurement request message is received as a start time of the measurement evaluation time if the reporting condition for the measurement report is met; waiting for a time at which the reporting condition for the measurement report is met if the reporting condition for the measurement report fails to be met; and using the time at which reporting condition for the measurement report is met as the start time. In this way, if the measurement report meets the reporting condition when the UE receives the measurement request message, the UE can use the time at which the UE receives the measurement request message as a start time for calculating the measurement evaluation time. Therefore, the UE can finish waiting earlier and report the measurement report to the access network device. The time for the access network device to wait for the UE to report the measurement report is shortened, and the objective of shortening the waiting time for the setup of the EPS FB call is achieved.

In an implementation, when the program instructions are executed by the processor, the terminal device is further enabled to implement the following method step: if the measurement result constantly meets the reporting condition for the measurement report within the measurement evaluation time, reporting the measurement report to the access network device after the measurement evaluation time ends.

In an implementation, when the program instructions are executed by the processor, the terminal device is enabled to specifically implement the following method steps: when the terminal device is configured to support the fallback of the IMS voice from the 5G network to the 4G network, determining whether to fall back to the 4G network based on a capability of the UE, an indication of an access and mobility management function AMF network element of a core network, network configuration, and/or a radio condition.

In an implementation, the access network device is a 5G access network NG-RAN.

According to a third aspect, an embodiment of this application further provides a computer-readable storage medium. The computer-readable storage medium stores instructions. When the instructions run on a computer, the computer is enabled to perform the methods according to the foregoing aspects and the implementations of the aspects.

According to a fourth aspect, an embodiment of this application further provides a computer program product including instructions. When the instructions run on a computer, the computer is enabled to perform the methods according to the foregoing aspects and the implementations of the aspects.

According to a fifth aspect, an embodiment of this application further provides a chip system. The chip system includes a processor which is configured to support the foregoing apparatus or system in implementing a function involved in the foregoing aspects, for example, generating or processing information involved in the foregoing method.

### BRIEF DESCRIPTION OF THE DRAWINGS

FIG. 1 is a schematic diagram of networking modes of a current 5G system;

FIG. 2 is a schematic diagram of network elements related to VoNR and EPS FB services in a 5G SA network;

FIG. 3 is a flowchart of current VoNR call setup;

FIG. 4 is a flowchart of current EPS FB call setup;

FIG. 5 is a schematic diagram of a structure of a terminal device 100 according to an embodiment of this application;

FIG. 6 is a flowchart of a cell measurement method according to an embodiment of this application;

FIG. 7 is a flowchart of step S101 of a cell measurement method according to an embodiment of this application;

FIG. 8 is a schematic diagram of storing historical LTE frequencies by using a FIFO queue according to an embodiment of this application;

FIG. 9 is a diagram of a scenario in which UE can perform no-gap measurement under different hardware capabilities according to an embodiment of this application;

FIG. 10 is a schematic diagram of a structure of a terminal device according to an embodiment of this application;

FIG. 11 is a schematic diagram of obtaining a location of a WAP by UE according to an embodiment of this application;

FIG. 12 is a schematic diagram of determining a current location of UE by UE itself based on a location of a WAP according to an embodiment of this application;

FIG. 13 is a schematic diagram of a manner of triggering cell measurement in a conventional solution;

FIG. 14 is a schematic diagram of a manner of triggering cell measurement according to an embodiment of this application;

FIG. 15 is a schematic diagram of determining a measurement sequence of target frequencies by UE according to an embodiment of this application;

FIG. 16 is a schematic diagram of determining a measurement sequence of target frequencies by UE according to an embodiment of this application;

FIG. 17 is a schematic diagram of a 5G NR control plane protocol stack on a UE side;

FIG. 18 is a schematic diagram of UE re-determining a target frequency based on a configuration delivered by an NG-RAN according to an embodiment of this application;

FIG. 19 is a schematic diagram of refreshing a measurement task by UE according to an embodiment of this application;

FIG. 20 is a flowchart of reporting a measurement report by UE to an NG-RAN according to an embodiment of this application;

FIG. 21 is a flowchart of EPS FB call setup according to an embodiment of this application;

FIG. 22 is a schematic diagram of a structure of a cell measurement device according to an embodiment of this application; and

FIG. 23 is a schematic diagram of a structure of a cell measurement device according to an embodiment of this application.

### DETAILED DESCRIPTION OF ILLUSTRATIVE EMBODIMENTS

The 5th generation mobile communication network (English: 5th generation mobile network, 5G) is a latest generation of mobile communication technology. Compared with early mobile communication technologies such as 4G, 3G, and 2G, 5G is capable of providing a higher data rate, a lower latency, and a fully connected Internet of things, is more energy saving, has lower costs and a higher system capacity, and supports massive connected devices.

5G New Radio (new radio, NR) is a new radio access technology (radio access technology, RAT), which is developed by the 3rd generation partnership project (3rd generation partnership project, 3GPP), and is used in 5G mobile communication networks and is a global standard for an air interface of 5G network.

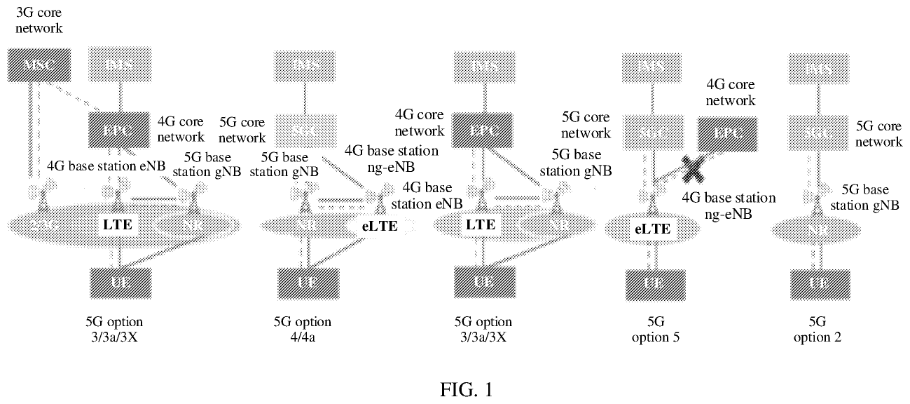

Currently, networking modes of a 5G system can include 5G non-standalone (NSA) and 5G standalone (SA) based on different core networks. Core networks of both 5G NSA and 5G SA can be a 4G core network EPC or a 5G core network 5GC. With reference to FIG. 1, the following briefly describes implementations of the two networking modes 5G NSA and 5G SA. As shown in FIG. 1:

5G Option 3/3a/3X networking is a current implementation of 5G NSA. NR is provided by a 5G base station gNB. The gNB then functions as a secondary base station of a 4G base station eNB, and is connected to the 4G core network EPC.

5G Option 7/7a/7X networking is a current implementation of 5G NSA. This implementation can be evolved from Option 3 series. With the deployment of 5GC, after the eNB that is originally connected to the EPC is upgraded to an ng-eNB, the Option 3 series networking that is originally connected the EPC is rehomed to the 5GC to form Option 7 series networking. The ng-eNB, also referred to as eLTE, is an upgraded 4G LTE base station, which supports access to the 5G core network 5GC.

5G Option 5 networking is another implementation of 5G SA. This networking is evolved from LTE networking. With the deployment of 5GC, the eNodeB that is originally connected to the EPC is upgraded to the ng-eNB and then is rehomed to the 5GC.

5G Option 2 networking is a target networking solution of 5G SA. The gNB is directly connected to the 5GC.

5G Option 4 networking is another implementation of 5G NSA. In this implementation, a secondary ng-eNB is added to the 5G Option 2 networking.

Currently, as specified in 3GPP, 5G SA uses a voice architecture of the 4G mobile communication network and still provides a voice service based on an IP multimedia subsystem (IP multimedia subsystem, IMS). A radio access technology of the 4G mobile communication network is long term evolution (long term evolution, LTE), and a voice call service carried over the 4G mobile communication network is called voice over LTE (VoLTE). A radio access technology of the 5G mobile communication network is NR as described above, and a voice call service carried over the 5G mobile communication network is called voice over NR (VoNR). VoNR will be the final solution for the voice service on 5G standalone (SA). In the early stage of 5G SA construction, 5G NR is not capable of providing the voice service. In this case, the voice service need to be implemented based on VoLTE. That is, when UE camping on NR initiates a call, fallback to the 4G network by using EPS FB (EPS Fallback) is required, and the voice service is carried by using VoLTE. Hence, in the early stage of 5G SA system construction, VoLTE and VoNR are used as different access modes for the 5G IMS voice service.

With reference to the accompanying drawings, the following briefly describes procedures of the two call manners: VoNR and EPS FB.

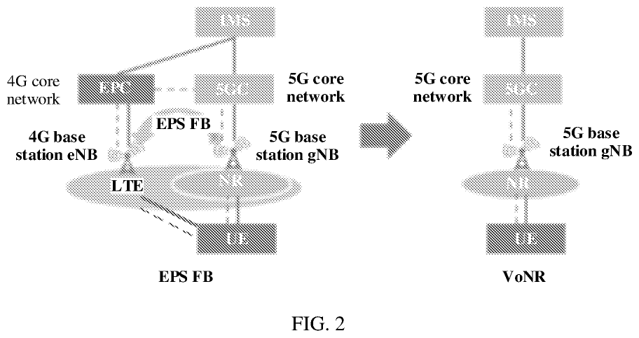

FIG. 2 is a schematic diagram of network elements related to VoNR and EPS FB services in a 5G SA network. As shown in FIG. 2, VoNR is carried by using a 5G core network 5GC and a 5G access network NG-RAN (for example, a gNB base station), and related network elements include user equipment UE, an NG-RAN, a 5GC, and an IMS. The VoLTE service is carried over a 4G core network EPC and a 4G access network E-UTRAN (for example, an eNB base station). Therefore, in addition to the network elements involved in the VoNR, the EPS FB service also includes the EPC and E-UTRAN.

For example, 5GC network elements involved in the VoNR service can include: an access and mobility management (access and mobility management function, AMF) network element, a session management function (session management function, SMF) network element, a user plane function (user plane function, UPF) network element, and a policy management and control function (policy control function, PCF).

The access and mobility management AMF network element is the most important network element in the 5GC, and is configured to process a control plane message of a network. Functions of the AMF include access network control plane processing, registration management, connection management, access management, mobility management, lawful interception of information, providing some special session management messages to the SMF, access authentication and authorization, security anchor function SEAF, location service management, EPS bearer ID allocation during interaction with the EPS in the 4G system, UE mobility event notification, optimization of data transmission in the control plane of the 5G Internet of things, and providing an external configuration parameter.

The session management function SMF network element is configured to implement session management. Functions of the SMF include establishment, modification and release of sessions, maintenance of a channel between the UPF and an access network node, IP address allocation and management the UE, selection and control of a user plane function, configuration of a correct service route on the UPF, implementation and execution of a policy control function, charging data collection, and providing a charging interface.

The user plane function UPF network element is configured to provide a user plane function. Functions of the UPF include, for example, anchor point for intra-system/inter-system mobility, UE IP address allocation based on an SMF request, a PDN session node connected to an external data network, data packet routing/forwarding, data packet check, user plane policy execution, lawful interception, service usage report, user plane QoS processing, uplink service verification (mapping from a service data flow (SDF) to a QoS flow), data packet marking on uplink and downlink transport layers, downlink data packet buffering and downlink data indication triggering, and sending or forwarding to a source cell a service transmission end marker (end marker) (from the SMF) after the inter-cell handover is complete, and providing a corresponding UE MAC address in response to Ethernet data transmission.

The policy control function PCF is used for supporting a unified policy framework that manages network behavior, providing a policy rule for the control plane to execute, and accessing subscription information that is in a UDR (user subscription data repository) and that is related to policy decision.

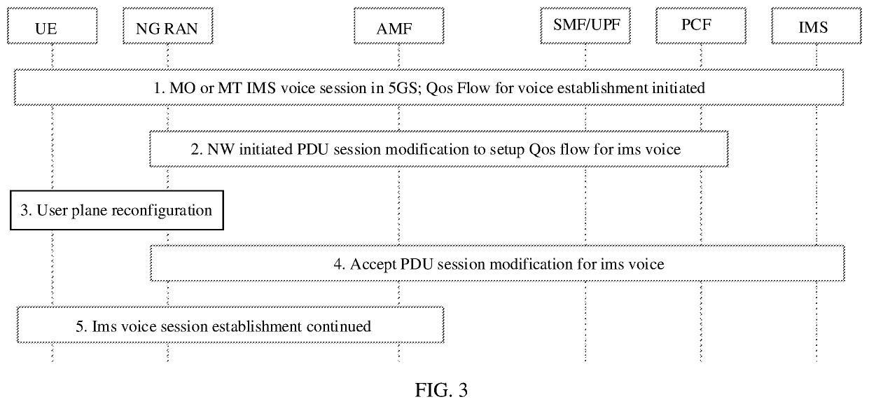

As shown in FIG. 3, when 5G NR provides a VoNR service, a VoNR call can be set up by using the following procedures 1-5:

1. In a scenario in which UE initiates a call or receives a call, an IMS triggers a procedure for setting up a dedicated bearer QoS flow for an IMS voice session based on SIP signaling interaction (1. MO or MT IMS voice session in 5GS; Qos Flow for voice establishment initiated).

2. A 5GC initiates a protocol data unit (protocol data unit, PDU) session modification procedure to initiate a request for setting up the dedicated bearer QoS flow to an NG-RAN. (2. NW initiated PDU session modification to setup Qos flow for IMS voice).

3. The NG-RAN reconfigures a user plane for the UE (3. User plane reconfiguration).

4. The NG-RAN accepts PDU session modification to set up the dedicated bearer of the IMS voice and notifies the AMF and PCF in the 5GC and the IMS of the successful bearer setup (4. Accept PDU session modification for IMS voice).

5. Setup of the IMS voice session continues (5. Ims voice session establishment continued).

EPC network elements involved in the EPS FB service can include, for example, a mobility management entity (mobility management entity, MME) network element, a serving gateway (serving gateway, SGW), and a packet data gateway (PDN gateway, PGW).

The mobility management entity MME network element is mainly configured to perform signaling processing and mobility management. Functions of the MME are, for example, NAS signaling and security thereof, tracking area (Tracking Area) list management, PGW and SGW selection, MME selection during inter-MME handover, selection of a serving GPRS support node (serving GPRS support node, SGSN) during handover to a 2G/3G access system, authentication, roaming control, and bearer management, mobility management between core network nodes in different 3GPP access networks, and lawful interception on a signaling plane.

The serving gateway SGW is a gateway oriented to an S1-U interface (an interface between the eNB and the SGW), is controlled by the MME and carries user plane data. Functions of the SGW are, for example, to serve as a local anchor point during an inter-eNodeB handover and assisting a reordering function in eNodeB; a mobility anchor point during handover between different 3GPP access systems, lawful interception, packet routing and forwarding, charging relating to uplink and downlink of the PDN and QoS class identifier (QoS class identifier, QCI).

The packet data network gateway PGW is connected to a packet data network (packet data network, PDN), is controlled by the MME and carries user plane data. Functions of the PGW are, for example: packet data routing and forwarding, UE IP address allocation, gateway function for accessing an external PDN, user-based packet filtering, lawful interception, charging and QoS policy enforcement, service-based charging, transport level packet marking in the uplink, uplink and downlink service level charging and service-based uplink and downlink rate control.

When the 5GC sends a request to the NG-RAN to set up the dedicated bearer QoS flow for the IMS voice session, if the NG-RAN does not have the VoNR capability, the NG-RAN determines whether to trigger EPS FB based on an NR capability of the UE, an N26 interface deployment situation, an LTE radio condition, and access and mobility management function (access and mobility management function, AMF) indication information. If EPS FB is triggered, the NG-RAN sends a redirection or inter-RAT handover request to the 5GC and waits for the UE to fall back to the LTE network. The EPC and E-UTRAN provide a voice service by using the VoLTE.

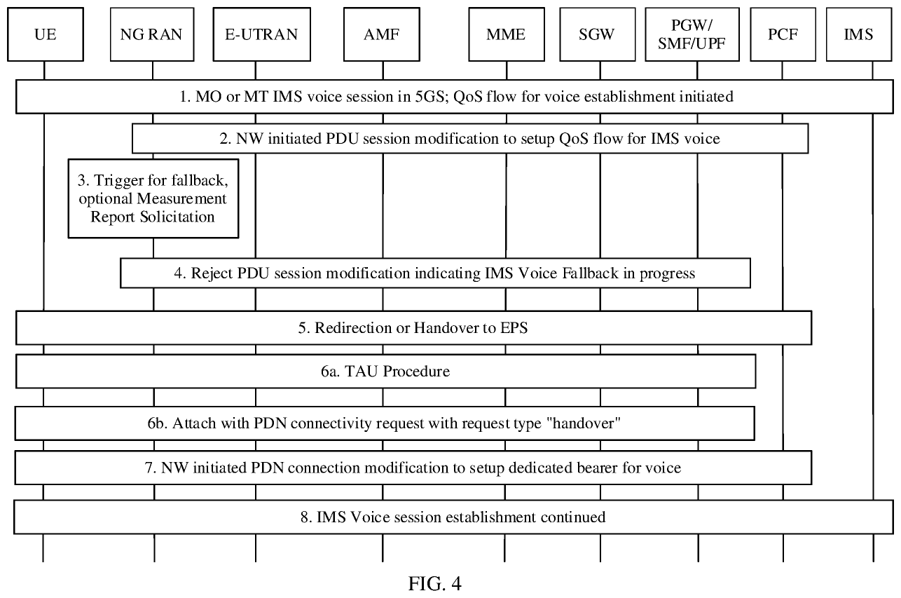

In a specific implementation, based on descriptions in the 3GPP technical specification TS 23.502, as shown in FIG. 4, an EPS FB procedure can specifically include the following steps.

1. In a scenario in which UE initiates a call or receives a call, an IMS triggers a procedure for setting up a dedicated bearer QoS flow for an IMS voice session based on SIP signaling interaction (1. MO or MT IMS voice session in 5GS; Qos Flow for voice establishment initiated).

2. A 5GC side initiates a protocol data unit (protocol data unit, PDU) session modification procedure to initiate a request for setting up the dedicated bearer QoS flow to an NG-RAN. (2. NW initiated PDU session modification to setup Qos flow for ims voice).

3. The NG-RAN is configured to support EPS FB of the IMS voice and determines whether to fall back to 4G, based on a UE capability, indication from the AMF that “redirection for EPS fallback is possible”, network configuration (for example, N26 availability configuration) and a radio condition. The NG-RAN can send an LTE measurement request message to the UE to collect a measurement report. Then, the UE needs to measure the LTE cell and send a measurement report to the NG-RAN (3. Trigger for fallback, optional Measurement Report Solicitation).

4. If falling back to 4G, the NG-RAN notifies the 5GC of a PDU session response message indicating that the PDU session modification is rejected and starts an IMS voice fallback procedure. The 5GC waits for the UE to fall back to the 4G (4. Reject PDU session modification indicating IMS Voice Fallback in progress).

5. The NG-RAN selects 6a or 6b based on the UE capability, the network configuration (for example, the N26 availability configuration) and the radio condition, and the UE is handed over to 4G by using inter-system inter-RAT handover or redirection (5. Redirection or Handover to EPS).

6a. The UE is handed over from 5G to 4G or falls back to 4G through inter-system redirection over an N26 interface. Then, a tracking area update procedure (6a. TAU Procedure).

6b. For inter-system redirection to 4G without the N26 interface, the UE initiates a connectivity request with a PDN attach request type of “handover” to the 5GC (6b. Attach with PDN connectivity request with request type “handover”).

7. After the UE falls back to the 4G network, the EPC (a fusion network element including SMF/PGW-C) initiates a PDU session modification procedure to send the request for setting up the dedicated bearer QoS flow to the access network E-UTRAN (7. NW initiated PDN connection modification to setup dedicated bearer for voice).

8. Setup of the IMS voice session continues. At least during an LTE voice call, E-UTRAN is configured not to trigger any handover to 5G (8. IMS Voice session establishment continued)

By comparing the foregoing VoNR procedure with the EPS FB procedure, it can be learned that the EPS FB procedure takes a longer waiting time for call setup compared with the VoNR procedure, because the procedure in which the NG-RAN determines whether to fall back to 4G, the procedure in which the UE measures the LTE cell, the inter-system (inter-RAT) handover or redirection procedure, and other procedures are added to the EPS FB procedure. Therefore, user experience is degraded.

To resolve the foregoing problem, an embodiment of this application provides a cell measurement method. The method can be applied to a terminal device UE and can shorten the waiting time for call setup of EPS FB. User experience is improved.

The terminal device in this embodiment of this application can include, for example, a mobile phone, a tablet computer, a personal computer, a workstation device, a large-screen device (for example, a smart screen or a smart television), a handheld game console, a home game console, a virtual reality device, an augmented reality device, a hybrid reality device, an in-vehicle intelligent terminal, a self-driving car, and customer-premises equipment (customer-premises equipment, CPE).

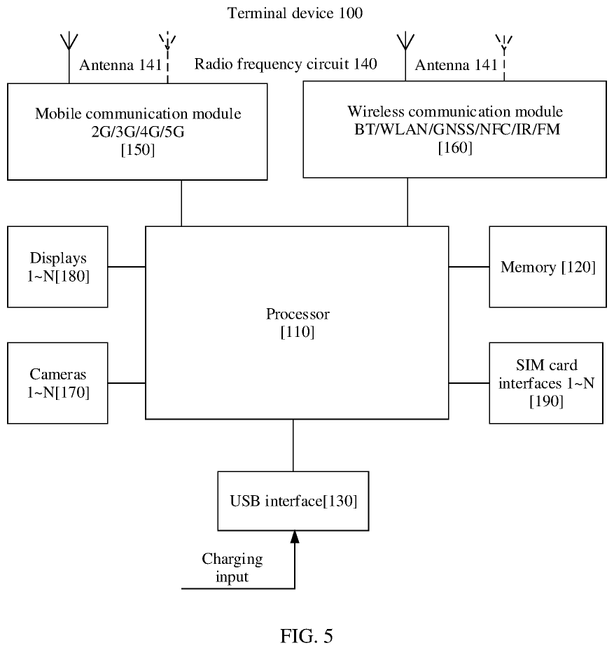

FIG. 5 is a schematic diagram of a structure of a terminal device 100 according to an embodiment of this application. As shown in FIG. 5, the terminal device 100 can include a processor 110, a memory 120, a universal serial bus (universal serial bus, USB) interface 130, a radio frequency circuit 140, a mobile communication module 150, a wireless communication module 160, a camera 170, a display 180, a subscriber identity module (subscriber identity module, SIM) card interface 190, and the like.

The processor 110 can include one or more processing units. For example, the processor 110 can include an application processor (application processor, AP), a modem processor, a graphics processing unit (graphics processing unit, GPU), an image signal processor (image signal processor, ISP), a video codec, a digital signal processor (digital signal processor, DSP), a baseband processor, and/or a neural-network processing unit (neural-network processing unit, NPU). Different processing units can be independent components, or can be integrated into one or more processors, for example, integrated into a system on a chip (system on a chip, SoC). The processor 110 can be further provided with a memory for storing instructions and data. In some embodiments, the memory in the processor 110 is a cache memory. The memory can store instructions or data that has been used or cyclically used by the processor 110.

In some embodiments, the processor 110 can include one or more interfaces. The interface can include an inter-integrated circuit (inter-integrated circuit, I2C) interface, an inter-integrated circuit sound (inter-integrated circuit sound, I2S) interface, a pulse code modulation (pulse code modulation, PCM) interface, a universal asynchronous receiver/transmitter (universal asynchronous receiver/transmitter, UART) interface, a mobile industry processor interface (mobile industry processor interface, MIPI), a general-purpose input/output (general-purpose input/output, GPIO) interface, a subscriber identity module (subscriber identity module, SIM) interface, and/or a universal serial bus (universal serial bus, USB) interface.

The memory 120 can be configured to store computer-executable program code, and the executable program code includes instructions. The memory 120 can include a program storage area and a data storage area. The program storage area can store an operating system, an application required by at least one function (for example, a sound play function or an image play function), and the like. The data storage area can store data (for example, audio data and a phone book) and the like created during use of the terminal device 100. In addition, the memory 120 can include one or more storage units, and can include, for example, a volatile memory (volatile memory) like a dynamic random access memory (dynamic random access memory, DRAM) and a static random access memory (static random access memory, SRAM), and can further include a non-volatile memory (non-volatile memory, NVM) like a read-only memory (read-only memory, ROM) and a flash memory (flash memory). The processor 110 runs the instructions stored in the memory 120 and/or the instructions stored in the memory disposed in the processor, to perform various function applications of the terminal device 100 and data processing.

A wireless communication function of the terminal device 100 can be implemented by using the radio frequency circuit 140, the mobile communication module 150, the wireless communication module 160, the modem processor, the baseband processor, and the like.

The radio frequency circuit 140 can include at least one antenna 141 to transmit and receive an electromagnetic wave signal. Each antenna in the terminal device 100 can be configured to cover one or more communication frequency bands. In some embodiments, the antenna can be used in combination with a tuning switch.

The mobile communication module 150 can provide a wireless communication solution that is applied to the terminal device 100 and that is used for 2G, 3G, 4G, 5G and the like. The mobile communication module 150 can include at least one filter, a switch, a power amplifier, a low noise amplifier (low noise amplifier, LNA), and the like. The mobile communication module 150 can receive an electromagnetic wave by using the antenna 141, perform processing such as filtering and amplification on the received electromagnetic wave, and transmit a signal to the modem processor for demodulation. The mobile communication module 150 can further amplify a signal modulated by the modem processor, and the antenna 141 converts an amplified signal into an electromagnetic wave and radiates the electromagnetic wave. In some embodiments, at least some functional modules in the mobile communication module 150 can be disposed in the processor 110. In some embodiments, at least some functional modules of the mobile communication module 150 and at least some modules of the processor 110 can be disposed in a same device.

The modem processor can include a modulator and a demodulator. The modulator is configured to modulate a low-frequency baseband signal to be sent into a medium-high frequency signal. The demodulator is configured to demodulate a received electromagnetic wave signal into a low-frequency baseband signal. Then, the demodulator transmits the low-frequency baseband signal obtained through demodulation to the baseband processor for processing. The low-frequency baseband signal is processed by the baseband processor and is then transmitted to the application processor. The application processor outputs a sound signal by using an audio device (which includes but is not limited to a loudspeaker, a receiver, or the like), or displays an image or a video on the display 180. In some embodiments, the modem processor can be an independent component. In some other embodiments, the modem processor can be independent of the processor 110, and is disposed in a same device as the mobile communication module 150 or another functional module.

The wireless communication module 160 can include a wireless fidelity (wireless fidelity, Wi-Fi) module, a Bluetooth (bluetooth, BT) module, a global navigation satellite system (global navigation satellite system, GNSS) module, a near field wireless communication (near field communication, NFC) module, an infrared (infrared, IR) module, and the like. The wireless communication module 160 can be one or more components where at least one of the foregoing modules is integrated. The wireless communication module 160 receives an electromagnetic wave by using the antenna 141, performs frequency modulation and filtering processing on an electromagnetic wave signal, and sends a processed signal to the processor 110. The wireless communication module 160 can further receive from the processor 110 a signal to be sent, perform frequency modulation and amplification on the signal, and the antenna 141 converts a modulated and amplified signal into an electromagnetic wave and radiates the electromagnetic wave.

In this embodiment of this application, the wireless communication functions of the terminal device 100 can include functions of a global system for mobile communication (global system for mobile communication, GSM), a general packet radio service (general packet radio service, GPRS), code division multiple access (code division multiple access, CDMA), wideband code division multiple access (wideband code division multiple access, WCDMA), time-division code division multiple access (time-division code division multiple access, TD-CDMA), long term evolution (long term evolution, LTE), 5th generation mobile communication new radio (5th generation mobile network new radio, 5G NR), BT, GNSS, WLAN, NFC, FM, and/or IR. The GNSS can include a global positioning system (global positioning system, GPS), a global navigation satellite system (global navigation satellite system, GNSS), a beidou navigation satellite system (beidou navigation satellite system, BDS), a quasi-zenith satellite system (quasi-zenith satellite system, QZSS), and/or a satellite based augmentation system (satellite based augmentation system, SBAS).

The camera 170 is configured to capture a static image or a video. The camera 170 includes a lens and a photosensitive element. An optical image of an object is generated by using the lens, and is projected onto the photosensitive element. The photosensitive element can be a charge-coupled device (charge-coupled device, CCD) or a complementary metal-oxide-semiconductor (complementary metal-oxide-semiconductor, CMOS) phototransistor. The photosensitive element converts an optical signal into an electrical signal, and then transmits the electrical signal to the ISP to convert the electrical signal into a digital image signal. The ISP outputs the digital image signal to the DSP for processing. The DSP converts the digital image signal into an image signal in a standard format, such as RGB, YUV, or RYYB. In some embodiments, the terminal device 100 can include one or N cameras 170, where N is a positive integer greater than 1.

The NPU is a neural-network (neural-network, NN) computing processor. The NPU quickly processes input information based on a structure of a biological neural network, for example, based on a transfer mode between human brain neurons, and can further continuously perform self-learning. Applications such as intelligent cognition of the terminal device 100, for example, image recognition, facial recognition, speech recognition, and text understanding, can be implemented by using the NPU.

The display 180 is configured to display an image, a video, and the like. The display 180 includes a display panel. The display panel can be a liquid crystal display (liquid crystal display, LCD), an organic light-emitting diode (organic light-emitting diode, OLED), an active-matrix organic light-emitting diode (active-matrix organic light-emitting diode, AMOLED), a flexible light-emitting diode (flexible light-emitting diode, FLED), a mini-LED, a micro-LED, a micro-OLED, a quantum dot light-emitting diode (quantum dot light-emitting diode, QLED), or the like. In some embodiments, the terminal device 100 can include one or N displays 180, where N is a positive integer greater than 1.

The SIM card interface 190 is configured to connect to a SIM card. The SIM card can be inserted into the SIM card interface 190 or removed from the SIM card interface 190, to implement contact with or separation from the terminal device 100. The terminal device 100 can support one or N SIM card interfaces, where N is a positive integer greater than 1. The SIM card interface 190 can support a nano-SIM card, a micro-SIM card, a SIM card, and the like. A plurality of cards can be inserted into the same SIM card interface 190 at the same time. The plurality of cards can be of a same type or different types. The SIM card interface 190 can be compatible with different types of SIM cards. The SIM card interface 190 is also compatible with an external memory card. The terminal device 100 interacts with a network by using the SIM card, to implement functions such as calling and data communication. In some embodiments, the terminal device 100 uses an eSIM, i.e., an embedded SIM card. The eSIM card can be embedded in the terminal device 100, and cannot be separated from the terminal device 100.

It can be understood that the structure illustrated in this embodiment of this application does not impose a specific limitation on the terminal device 100. In some other embodiments, the terminal device can include more or fewer components than those shown in the figure, or some components can be combined, or some components can be split, or a different component arrangement can be used. The components shown in the figure can be implemented in hardware, software, or a combination of software and hardware.

The cell measurement method provided in the embodiment of this application can be applied to a scenario in which the terminal device UE camps on a 5G access network NG-RAN. As shown in FIG. 4 and FIG. 6, a measurement method for fast EPS FB can include the following steps.

Step S101: In a scenario in which UE initiates a call or receives a call, an IMS triggers a procedure for setting up a dedicated bearer QoS flow for an IMS voice session based on SIP signaling interaction (1. MO or MT IMS voice session in 5GS; Qos Flow for voice establishment initiated). At the same time, the UE measures an LTE cell.

In step S101, that “in a scenario in which UE initiates a call or receives a call, an IMS triggers a procedure for setting up a dedicated bearer QoS flow for an IMS voice session based on SIP signaling interaction” is the same as step 1 in FIG. 4. In a scenario in which the UE initiates a call, when a subscriber dials a number, the UE initiates a voice call on the IMS system by using SIP signaling. When the voice call is initiated, the UE can start measuring the LTE cell without waiting for a measurement request message from the NG-RAN. In a scenario in which the UE receives a call, the IMS system sends a call request to the UE by using SIP signaling. When the UE receives the call request, the UE can start measuring a cell without waiting for the measurement request message from the NG-RAN.

Step S102: A 5GC side initiates a protocol data unit (protocol data unit, PDU) session modification procedure to send a request for setting up the dedicated bearer QoS flow to an NG-RAN. (2. NW initiated PDU session modification to setup Qos flow for ims voice).

Step S102 is the same as step 2 in FIG. 4.

Step S103: When the NG-RAN is configured to support EPS FB of IMS voice and determines, based on a UE capability, indication from the AMF that “redirection of EPS fallback is possible”, network configuration (for example, N26 availability configuration), and a radio condition, whether the IMS voice falls back to 4G, the NG-RAN can initiate a measurement request message to the UE to collect a measurement report. When receiving the measurement request message from the NG-RAN, the UE reports a measurement report to the NG-RAN based om a measurement result of the LTE cell measurement.

Because the UE has performed cell measurement before receiving the measurement request message, when receiving the measurement request message from the NG-RAN, the UE can report the measurement report to the NG-RAN earlier based on the measurement result of the LTE cell measurement that has been completed in advance. Time for the NG-RAN to wait for the UE to report the measurement report is shortened.

In this way, the UE, the NG-RAN, the 5GC, and the IMS system can continue to perform steps 4 to 8 in FIG. 4 until the EPS FB procedure is completed and the IMS voice bearer is set up. It can be understood that, in the method in this embodiment of this application, the procedure where the UE performs the cell measurement is performed in advance in step 1 in FIG. 4. Therefore, when the NG-RAN sends the LTE measurement request message to the UE, the UE can report the measurement report to the NG-RAN earlier based on the measurement result of the LTE cell measurement that has been completed in advance. Time for the NG-RAN to wait for the UE to report the measurement report is shortened. The objective of shortening the waiting time for setup of the EPS FB call is finally achieved.

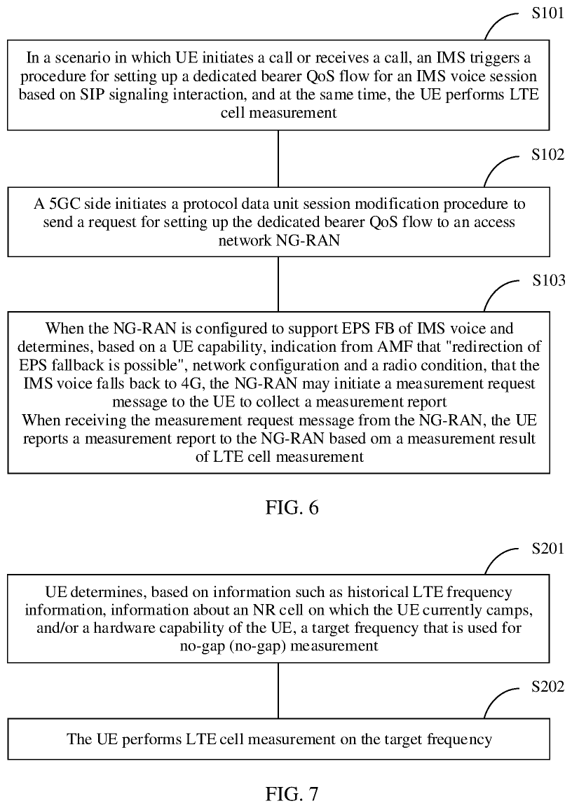

In an embodiment, as shown in FIG. 7, that the UE performs LTE cell measurement in step S101 can be implemented by using the following steps.

Step S201: The UE determines, based on information such as historical LTE frequency (carrier frequency) information, information about an NR cell on which the UE currently camps, and/or a hardware capability of the UE, a target frequency that is used for no-gap (no-gap) measurement.

The historical LTE frequency information can include a frequency of an LTE cell on which the UE camped for a period of time before the current time.

In an implementation, the UE can maintain a list that includes historical LTE frequencies. When the UE is registered with the network, each time UE is handed over to a new LTE cell, the UE can record information about the LTE cell in the list of historical LTE frequencies, such as a frequency, a cell ID, tracking area information, cell location information, a time at which the UE enters the LTE cell, and a time at which the UE leaves the LTE cell. The UE can store the information about the LTE cell in the list for a period of time, for example, for several hours, for one day, or for several days. When the information about a given LTE cell has been stored longer than this period of time, the UE can delete the information from the list, so that the list always stores information about an LTE cell that the UE has camped on for a period of time before the current time.

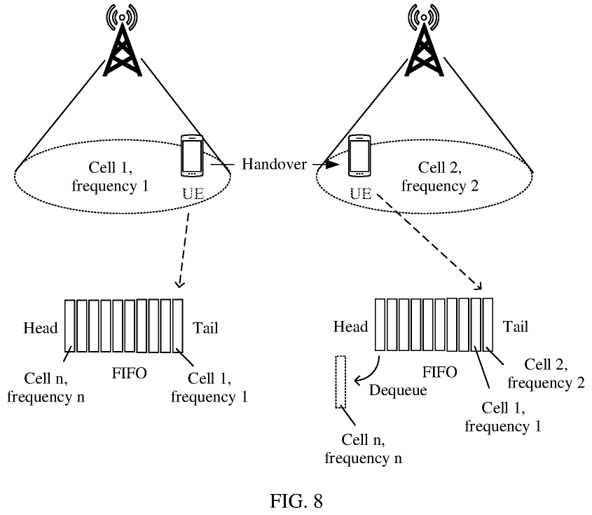

In an implementation, the UE can also store historical LTE frequencies in a queue with a regular queue length. As shown in FIG. 8, the queue can be a first-in first-out (first in, first out, FIFO) queue. When the UE is registered with the network, each time UE is handed over to a new LTE cell, the UE can add the information about the LTE cell (including at least the frequency information) to the FIFO queue. Information about different LTE cells is recorded in the FIFO queue based on a first-in-first-out sequence. When the FIFO queue is full, information about the LTE cell that is first added to the queue will be out of the queue if information about a new LTE cell is added to the queue.

For example, as shown in FIG. 8, the length of the FIFO queue is 10, and information about 10 LTE cells can be stored in total. After the FIFO queue is full, if the UE is handed over from an LTE cell 1 (a frequency 1) to an LTE cell 2 (a frequency 2), the UE adds cell information about the LTE cell 2 (such as the frequency 2, a cell ID, cell location information, a time at which the UE enters the LTE cell, and a time at which the UE leaves the LTE cell) to the end of the FIFO queue. In addition, cell information (a cell n and a frequency n) that is enqueued first at the head of the FIFO queue would be dequeued from the queue.

In this embodiment of this application, information about the NR cell on which the UE currently camps can include a frequency, a cell location, and the like.

In this embodiment of this application, the hardware capability of the UE can be a quantity of radio frequency receivers (for example, antennas) of the UE. The quantity of the radio frequency receivers of the UE is related to a frequency measurement capability of the UE, including whether the UE can perform the no-gap measurement on a frequency, and the like. The following briefly describes the capability.

For ease of understanding of this solution, a meaning of a measurement gap (measurement gap) is first explained and described. According to 3GPP TS 36.300, cell measurement can be classified into intra-frequency measurement (intra-frequency measurement) and inter-frequency measurement (inter-frequency measurement). Intra-frequency measurement means that a cell on which UE currently camps and a target cell to be measured are on a same frequency. Inter-frequency measurement means that a cell on which UE currently camps and a target cell are not on a same frequency. In this application, to avoid affecting the setup of the VoNR service, a no-gap measurement manner can be used. That is, a network side does not need to allocate a measurement gap to perform LTE cell measurement. Information about an LTE cell can be quickly measured without interrupting the VoNR service. However, this is not limited in this application, and the gap measurement manner can also be used.

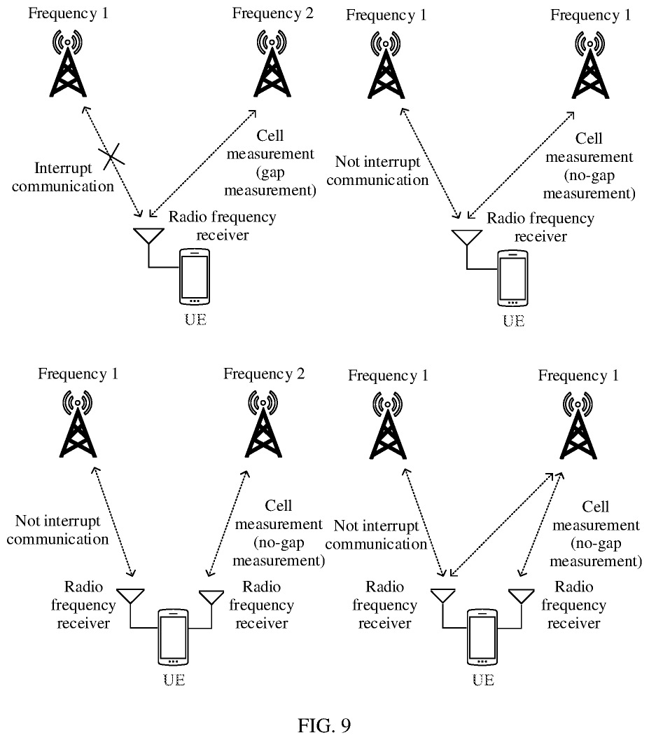

FIG. 9 shows a scenario in which UE can perform no-gap measurement with different hardware capabilities. As shown in FIG. 9, if the UE includes only one radio frequency receiver, it means that the UE can receive and transmit a signal only on one frequency (for example, the frequency 1) at a same time. Therefore, when the UE needs to perform inter-frequency measurement, the UE needs to temporarily switch the receiver to another frequency (for example, the frequency 2) for a period of time, to perform cell measurement. This period is a measurement gap. During the measurement gap, the UE cannot perform data communication with the cell on which the UE currently camps. After the measurement gap ends, the UE needs to switch the receiver back to the frequency of the cell on which the UE currently camps, so that data communication with the cell on which the UE currently camps is restored. When the UE needs to perform intra-frequency measurement, the UE does not need to switch the frequency of the radio frequency receiver to implement measurement of the target cell, without interrupting data transmission with the cell on which the UE currently camps. Therefore, a measurement gap is not required, and this is no-gap measurement. If the UE includes two or more radio frequency receivers, the UE can use one of the radio frequency receivers to perform data communication on a frequency (for example, the frequency 1) of a cell on which the UE currently camps, and use another radio frequency receiver to perform intra-frequency measurement on the same frequency (for example, the frequency 1), or use another radio frequency receiver to perform inter-frequency measurement on another frequency (for example, the frequency 2). A gap measurement is not required in either measurement scenarios. This is no-gap measurement.

Hence, whether the UE can perform the no-gap measurement on a frequency depends on the hardware capability of the UE.

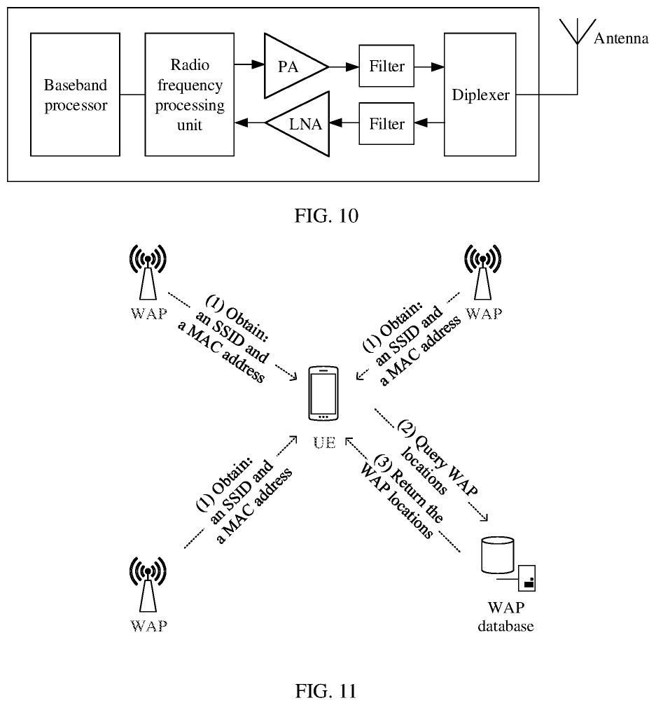

For example, FIG. 10 is a schematic diagram of a typical terminal device. The terminal device includes a baseband processor, a radio frequency processing unit (RFIC), a power amplifier (PA), a filter, a duplexer, an antenna, and the like. A chip platform, a radio frequency front-end, and an antenna form a wireless communication module of the terminal. The chip platform includes a baseband chip, a radio frequency chip, a power management chip, and the like. The baseband chip is responsible for a physical layer algorithm, processing of a high-layer protocol, and implementation of multi-mode interworking. The radio frequency chip is responsible for mutual conversion between a radio frequency signal and a baseband signal. A radio frequency front-end module is a necessary path for connecting the radio frequency processing unit to the antenna. As shown in FIG. 10, the terminal device mainly includes a power amplifier (PA), a filter (Filter), a duplexer or multiplexer (Duplexer or Multiplexer), a low noise amplifier (LNA), and a switch (Switch) or an antenna switch module (ASM). In some architectures of the radio frequency front-end of the terminal, components such as a diplexer (Diplexer) and a coupler (Coupler) are added behind an antenna switch.

However, in general, a measurement capability indicating whether a gap is required in inter-frequency or inter-system measurement depends on a quantity of receive channels of the radio frequency processing unit RFIC. In this embodiment, it is assumed that the radio frequency front-end FEM (including a power amplifier, a filter, the duplexer, and the like) of the terminal device supports three frequency bands (B1, B3, and B7), the RFIC features four receive channels (Rx 1, Rx 2, Rx 3, and Rx 4). In this case, a BBIC can support both data receiving/sending in a serving cell and inter-frequency measurement. It is assumed that an inter-system frequency and a frequency of the serving cell also support a CA combination. In this case, the BBIC also supports both data receiving/sending in the serving cell and inter-system measurement. Table 1 shows an inter-frequency measurement capability (for example, by using an InterFreq NeedforGaps command) of the terminal device, which is referred to as a “measurement capability”, “whether a gap capability needs to be allocated”, “a gap capability”, “a gap measurement capability”, or the like.

TABLE 1

| InterFreq | | | [1A] | | 1A + | 1A + | 1A + | 3A + | 3A + | 3A + | 7A + |
|---|---|---|---|---|---|---|---|---|---|---|---|
| NeedforGaps | 1A | 3A | 4Rx | 7A | 3A | 7A | 1A | 1A | 3A | 7A | 3A |
| Band1 | F | F | T | T | T | T | T | T | T | T | T |
| Band3 | F | F | T | F | T | T | T | T | T | T | T |
| Band7 | F | F | T | T | T | T | T | T | T | T | T |

As shown in Table 1, 1A, 3A, and 7A identify component carriers on different frequency bands (the frequency bands are a band 1, a band 2, and a band 3). Each frequency band occupies two receive channels of the terminal device. [1A] indicates that four receive channels are occupied, and T indicates that a gap needs to be allocated. It can be learned that when the terminal device features a CA combination or 4Rx, the network needs to allocate a gap for inter-frequency measurement. A specific description is as follows: Currently, the terminal device receives and sends data on a 1A frequency band (for example, the terminal device camps on a first cell). The 1A frequency band occupies two receive channels (for example, Rx1 and Rx2). In this case, the network allocates a gap measurement, and measurement on a neighboring cell is performed by using only the Rx3 and Rx4 channels, and a network side does not need to allocate a gap. However, when the terminal device is in a [1A] frequency band, that is, four channels Rx1, Rx2, Rx3, and Rx4 are occupied, a network side needs to allocate a gap to measure network quality of the neighboring cell. When all the four channels of the terminal device are occupied, data receiving and sending of the terminal device in the serving cell must be suspended to allocate any two channels (for example, Rx1 and Rx2) to the terminal device for measuring the neighboring cell. Similarly, when the terminal device performs data receiving and sending by using a CA capability, for example, in a 1A+3A scenario, a total of four channels are occupied to measure the neighboring cell. Because all channel resources of the terminal device are currently occupied, the network needs to allocate a gap for measuring network instructions of the neighboring cell. Consequently, a current service is interrupted.

In the foregoing embodiment, the network allocates a different frequency or a different system to the terminal device for monitoring and measurement. In this case, when the terminal device measures the neighboring cell, the terminal device cannot receive or send data, which causes problems such as suspension and delay when a user receives or sends data. User experience is poor. It should be noted that in this application, the different frequency can refer to a frequency band with a different center frequency, and can be understood as an inter-frequency. The different system refers to a system with a different network standard, and can be understood as different system, for example, 3G or 4G.

In this embodiment of this application, to ensure that the UE can also receive and send data during the cell measurement, the target frequency mainly includes a frequency that can enable the UE to perform no-gap (no-gap) measurement. In some implementations, the UE can determine the target frequency by using a plurality of implementations based on information such as historical LTE frequencies, information about a new radio NR cell on which the UE currently camps, and a hardware capability of the UE. For example, implementation A: The UE can select, from historical LTE frequencies based on the hardware capability of the UE, all frequencies on which the no-gap measurement can be performed as a target frequency.

Implementation B: The UE sets a maximum quantity of target frequencies. After selecting all the frequencies on which the no-gap measurement can be performed from the historical LTE frequencies, the UE determines whether a quantity of the selected frequencies is less than the maximum quantity. If the quantity of the selected frequencies is less than or equal to the maximum quantity, all the selected frequencies are used as the target frequency. If the quantity of the selected frequencies is greater than the maximum quantity, frequencies whose quantity is less than or equal to the maximum quantity can be selected from the selected frequencies as the target frequencies. A selection manner can be, for example, based on a chronological order of the UE entering the historical frequencies, camping duration of the UE camping on the historical frequencies, and cell signal strength corresponding to the historical frequencies. This is not limited in embodiments of this application.

Implementation C: The UE sets a validity period of the target frequency. The validity period is a period value, for example, 30 minutes, 1 hour, or 10 hours. After selecting all the frequencies on which the no-gap measurement can be performed from the historical LTE frequencies, the UE can calculate, for each frequency, whether a time interval Δt between a time at which the UE leaves a cell corresponding to the frequency for the last time and a current time is less than or equal to the validity period. If the time interval Δt is less than or equal to the validity period, the frequency can be used as the target frequency. If the time interval Δt is greater than the validity period, the corresponding frequency is discarded.

Implementation D: The UE can determine the target frequency based on a current location of the UE. For example, after selecting all the frequencies on which the no-gap measurement can be performed from the historical LTE frequencies, the UE can determine, for each frequency, a distance L between a location of an LTE cell corresponding to the frequency and a current location of the UE, and determine whether L is less than or equal to a preset distance threshold Lo. If L is less than or equal to the preset distance threshold Lo, the frequency can be used as the target frequency. If L is greater than the preset distance threshold Lo, the corresponding frequency is discarded.

Implementation E: The UE can record an LTE cell to which the UE has been successfully handed over or redirected during camping on the current NR cell. In addition, if the UE has been successfully handed over or redirected back to the current NR cell from an LTE cell, the UE also records the cell. In this way, the UE can determine an association relationship between the NR cell and the LTE cell based on a record of handover or redirection of the UE between the NR cell and the LTE cell. For example, if an NR cell on which the UE currently camps is a Cell 1, the UE has been successfully handed over or redirected to an LTE Cell 2 and LTE Cell 3 during camping on the Cell 1, and the UE has been handed over back from an LTE cell Cell 4 to the Cell 1, the UE may determine that the Cell 1 has an association relationship with the Cell 2, the Cell 3, and the Cell 4. Further, in step S201, the UE can use frequencies corresponding to all LTE cells associated with the NR cell on which the UE currently camps as the target frequencies. The handover or redirection can be triggered by using an EPS FB procedure, or can be triggered by using mobility management in an RRC_CONNECTED state of the UE. This is not limited in embodiments of this application.

It can be understood that the foregoing manner for the UE determining the target frequency is merely a part rather than all of implementations that can be used in this embodiment of this application. A person skilled in the art can further determine the target frequency in other manners under teaching of the technical concept of this embodiment of this application. These manners do not go beyond the protection scope of this embodiment of this application.

Optionally, the current location of the UE can be determined by using the following first to fourth methods.

A first method is to determine a current location of the UE by using GNSS satellite positioning information. The method can be applied to a scenario where the UE is located at a place having a good satellite signal, for example, being located outdoors. In a specific implementation, when initiating an IMS call or receiving an IMS call request, the UE can enable a location service of the UE. In this way, the UE can search for a satellite signal of a global positioning system GPS, a BeiDou navigation satellite system BDS and other systems, to determine a current location of the UE.

In addition, considering that GNSS satellite positioning can require a specified time, to avoid a positioning process occupying an EPS FB time, the UE can further choose the following implementation to determine a current location of the UE. In a scenario in which the UE initiates an IMS call, the UE can enable the location service when a user opens a dialing interface or a contact interface, to determine the current location of the UE in advance. When the UE receives the IMS call request, the UE can directly use a location determined when the location service is enabled last time as a current location of the UE. Generally, because many applications and services in the UE need to be implemented based on the location service, the location service is frequently enabled. Therefore, the location that is determined when the UE enabled the location service last time does not deviate greatly from the current location of the UE, and can be used for the UE to select a frequency.

A second method is to determine a current location of the UE through Wi-Fi positioning. The method can be applied to a scenario in which the UE is located at a place having a poor satellite signal, for example, being located indoors. In a specific implementation, as shown in FIG. 11, the UE can enable Wi-Fi scanning when the UE is connected to a Wi-Fi network or is not connected to a Wi-Fi network, to obtain information about a surrounding Wi-Fi wireless access point (wireless access point, WAP), for example, a service set identifier (service set identifier, SSID) and/or a media access control (media access control address, MAC) address of a WAP. After obtaining SSID and/or MAC address of one or more WAPs, the UE can query a WAP database based on the SSID and/or MAC address, to obtain a location of the WAP from the database. The current location of the UE is further determined based on the location of the WAP.

The WAP database can be pre-stored in the UE, or can be stored in a specified network location. The WAP database can record information such as the SSID and/or MAC address of the WAP, and location information about the WAP. The location information can be information such as a longitude, a latitude, and an altitude of the WAP. This is not limited in embodiments of this application.

When the WAP database is stored in a network location, the UE needs to initiate a query request carrying the SSID and/or MAC address of one or more WAPs to the network location, so that the network location returns corresponding WAP location information.

In some implementations, the UE can determine the current location of the UE based on the location of the WAP by using the following manners.

Implementation a: When the UE obtains a location of only one WAP, the UE directly uses the location of the WAP as a current location of the UE.

Implementation b: When the UE obtains locations of two or more WAPs, the UE can use a location of a WAP having best signal strength as a current location of the UE, where the signal strength can be, for example, a received signal strength indicator (received signal strength indicator, RSSI) of the WAP.

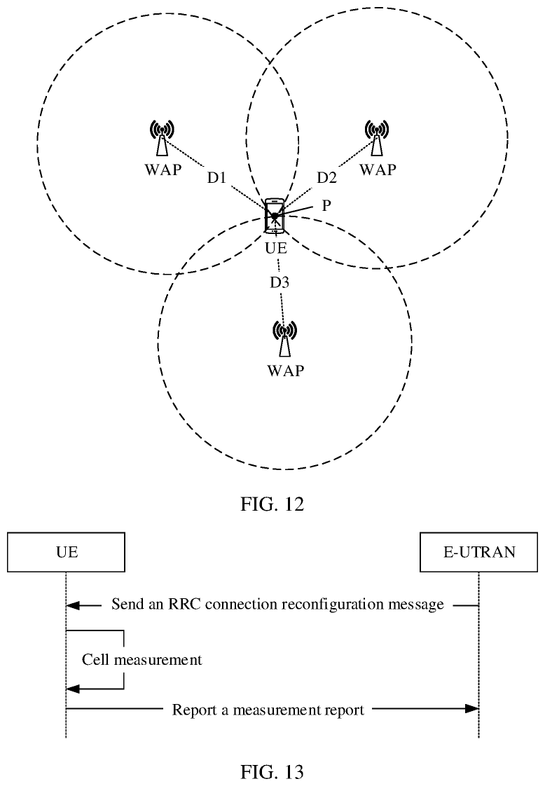

Implementation c: When the UE obtains positions of three or more WAPs, the UE can perform signaling interactions with at least three WAPs to determine a current location of the UE through time of flight (time of flight, ToF) ranging, or time difference of arrival (time difference of arrival, TDoA) ranging. Taking the ToF ranging as an example, the UE can select three WAPs having the highest signal strength based on the RSSIs of the WAPs. Then, the UE performs ranging message interactions with the three WAPs to respectively determine distances D1, D2, and D3 between the UE and the three WAPs. Finally, as shown in FIG. 12, the UE can draw circles by using positions of the three WAPs as centers and using corresponding distances, and the obtained intersection point P is the current location of the UE.

It should be additionally noted herein that, the target frequency may not need to be selected strictly based on the distance. Therefore, the UE may not need to accurately obtain the current position. In this case, to improve a positioning speed of the UE, the UE can preferably use the manner a and the manner b to determine the current location of the UE.

A third method is to determine a current location of the UE through base station positioning. The method can be applied to a scenario in which the UE has registered with a 5GS service. In a specific implementation, after registering with the 5GS service, the UE can obtain base station information about an NR cell on which the UE camps, for example, information such as a mobile country code (mobile country code, MCC), a mobile network code (mobile network code, MNC), a location area code (location area code, LAC), and/or a cell number Cell ID. Then, the UE can query a base station positioning database based on the base station information, obtain a location of the base station from the base station positioning database, and further determine a current location of the UE based on the location of the base station.

The base station positioning database can be pre-stored in the UE, or can be stored in a specified network location. The base station positioning database can record information such as the MCC, MNC, LAC, and/or cell ID of the base station, and location information about the base station. The location information can be information such as a longitude, a latitude, and an altitude of the base station. This is not limited in embodiments of this application.

When the base station positioning database is stored in a network location, the UE needs to initiate, to the network location, a query request carrying base station information about an NR cell on which the UE camps, so that the network location returns location information about a corresponding base station.

In some implementations, the UE can determine the current location of the UE according to the location of the base station in the following manner:

Implementation d: The UE uses a base station location of the NR cell on which the UE camps as a current location of the UE.

Implementation e: When the UE camps on two cells at the same time, the UE can use one of the two cells that has stronger signal strength as a current location of the UE. The signal strength can be information such as a received signal strength indicator RSSI and a reference signal received power (reference signals received power, RSRP) of the base station. Generally, when two SIM cards are installed on a UE that supports dual-SIM standby, the UE camps on two cells at the same time, for example, an NR cell and an LTE cell.

A fourth method: the UE can determine a current location of the UE based on a specific scenario. The specific scenario is that, for example, the user is at home, or the user is at a work place. The UE can associate each scenario with a location based on a user mark or by using a machine learning manner. For example, when the machine learning manner is used for implementation, the UE can analyze a change rule of locations of the UE over time by using GNSS positioning data obtained over a period of time. If the UE finds by analysis that the user is located at a given location A for a long time in daytime, the UE can determine, based on map data, that the location A is a non-residential area like an office building, a business district, or an industrial district. In this case, the UE can determine that the location A corresponds to the scenario in which the user is at the workplace. Similarly, if the UE finds by analysis that the user is located at a location B at night for a long time, the UE can determine, based on the map data, that the location B is a residential area, and the UE can determine that the location B corresponds to the scenario in which the user is at home.

In addition, the UE can record information such as an SSID and a MAC of an accessed Wi-Fi network in each scenario and information such as the cell ID of the NR cell on which the UE camps. In this way, the UE can determine, based on information such as the SSID, the MAC address, or the cell ID, whether the UE is currently connected to the Wi-Fi network or NR cell in the foregoing scenario. If the UE is currently connected to a Wi-Fi network or an NR cell in a given scenario, it indicates that a location associated with the scenario is a current location of the UE.

It can be understood that the foregoing method for the UE determining the current location of the UE is merely a part rather than all of the methods that can be used in the embodiments of this application. A person skilled in the art can further determine the current location of the UE by using another method under the teaching of the technical concept of the embodiments of this application. These methods do not go beyond the protection scope of the embodiments of this application.

It should be additionally noted herein that the UE can determine the target frequency by using one or a combination of the plurality of implementations of the foregoing implementations A-D based on information such as the historical LTE frequency information, the information about a new radio NR cell on which the UE currently camps, and the hardware capability of the UE. This is not limited in embodiments of this application. For example, when the UE sets the maximum quantity of the target frequencies by using the foregoing implementation B, if the quantity of frequencies on which the no-gap measurement can be performed is greater than the maximum quantity, the UE can further select, by using the foregoing implementation C and/or implementation D, target frequency from all the frequencies on which the no-gap measurement can be performed. For a specific process, refer to content in the foregoing implementation C and implementation D. Details are not described herein again.

In some embodiments, when the UE determines the target frequency by using the implementation C or the implementation D, the UE can further set a minimum quantity of the target frequencies.

Implementation C is used as an example. After selecting all the frequencies on which the no-gap measurement can be performed from the historical LTE frequencies, the UE can select, for the first time based on a default validity period, frequencies that meet a condition. Then, the UE determines whether the quantity of the frequencies selected for the first time is greater than the minimum quantity. If the quantity of the frequencies selected for the first time is greater than or equal to the minimum quantity, the UE stops selection and uses the frequencies selected for the first time as the target frequencies. If the quantity of the frequencies selected for the first time is less than the minimum quantity, the UE can prolong the validity period and select frequencies that meet the condition for the second time based on the prolonged validity period. Then, the UE determines whether a quantity of the frequencies selected for the second time is greater than the minimum value. If the quantity of the frequencies selected for the second time is greater than or equal to the minimum quantity, the UE keeps prolonging the validity period, and frequencies are selected again, and so on, until the quantity of the frequencies is greater than or equal to the minimum quantity.

Implementation D is used as an example. After selecting all the frequencies on which the no-gap measurement can be performed from the historical LTE frequencies, the UE can select, for the first time based on a default distance threshold, frequencies that meet a condition Then, the UE determines whether the quantity of the frequencies selected for the first time is greater than the minimum quantity. If the quantity of the frequencies selected for the first time is greater than or equal to the minimum quantity, the UE stops selection and uses the frequencies selected for the first time as the target frequencies. If the quantity of the frequencies selected for the first time is less than the minimum quantity, the UE can increase the distance threshold and select frequencies that meet the condition for the second time based on the increased distance threshold. Then, the UE determines whether a quantity of the frequencies selected for the second time is greater than the minimum value. If the quantity of the frequencies selected for the second time is greater than or equal to the minimum quantity, the UE keeps prolonging the validity period, and frequencies are selected again, and so on, until the quantity of the frequencies is greater than or equal to the minimum quantity.

Step S202: The UE performs LTE cell measurement on the target frequency.

When there are a plurality of target frequencies, the UE can sequentially perform cell measurement on each target frequency based on a specified sequence. For example, the UE can sequentially receive signals such as a primary synchronization signal (primary synchronization signal, PSS), a secondary synchronization signal (secondary synchronization signal, SSS), and a system information block (system information block, SIB) at each target frequency and around the target frequency based on the specified sequence, to search for an LTE cell, and obtain, based on the signal receiving strength, a reference signal received power (reference signal received power, RSRP) and reference signal received quality (reference signal received quality, RSRQ) of the LTE cell, a received signal strength indicator (Received Signal Strength Indicator, RSSI), a reference signal time difference (Reference Signal Time Difference, RSTD), a path loss or other parameters for evaluating cell quality of the LTE cell.

It should be additionally noted herein that a cell measurement triggering manner in this embodiment of this application is different from a cell measurement triggering manner in a conventional solution. The following provides comparison and description with reference to some accompanying drawings.

FIG. 13 is a schematic diagram of a cell measurement triggering manner in a conventional solution. As shown in FIG. 13, in a conventional solution, UE triggers cell measurement under control of an E-UTRAN. For example, when the E-UTRAN requires the UE to perform cell measurement, the E-UTRAN can send a radio resource control (radio resource control, RRC) connection reconfiguration message (RRC connection reconfiguration) to the UE. The RRC connection reconfiguration message can include cell measurement configuration, for example, a measurement object (measurement object), and a measurement reporting configuration (reporting configuration). The measurement object can include, for example, a frequency that requires measurement by the UE. The measurement reporting configuration can include, for example, a reporting standard and a reporting format, where the reporting standard specifically refers to a standard, a period, or an event description that triggers the UE to send a measurement report, and the reporting format describes parameter information that is required in the measurement report of the UE. Next, after receiving the RRC connection reconfiguration message, the UE performs cell measurement according to configuration in the RRC connection reconfiguration message, and reports a measurement report (measurement report) to the E-UTRAN when the measurement results meet the reporting standard.

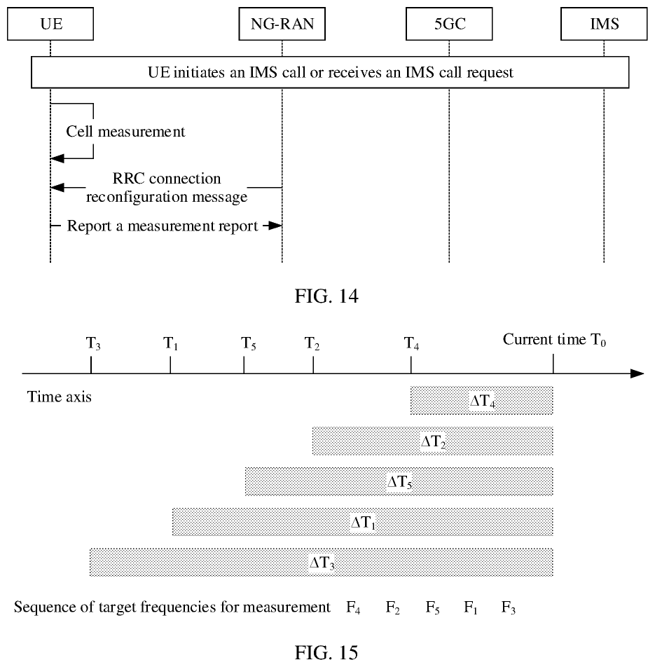

FIG. 14 is a schematic diagram of a cell measurement triggering manner according to an embodiment of this application. As shown in FIG. 14, in this embodiment of this application, UE does not use receipt of an RRC connection reconfiguration message as a condition of triggering cell measurement. Instead, the UE starts cell measurement automatically when initiating an IMS call or receiving an IMS call request. In addition, in this embodiment of this application, when the UE starts to perform cell measurement, a target frequency to be measured by the UE is not configured by using the RRC connection reconfiguration message, but is determined by the UE based on information such as historical LTE frequency information, information about a new radio NR cell on which the UE currently camps, and a hardware capability of the UE.

It can be learned that, in the technical solution of this embodiment of this application, the UE does not need to use the RRC connection reconfiguration message as a condition of triggering the cell measurement. Therefore, if the UE receives the RRC connection reconfiguration message after starting the cell measurement, the UE can report a measurement report earlier based on a previous measurement result.

In some implementations, when the UE performs the LTE cell measurement, the UE can determine the measurement sequence of the target frequencies in the following manner.

In a first implementation, the UE can determine a time interval Δ between a time at which the UE camps on each target frequency and a current time, and then determines a sequence of the target frequencies on which the cell measurement is performed based on a descending order of time intervals ΔT. During a specific implementation, for any target frequency i, the UE can determine a time Tᵢ at which the UE leaves an LTE cell corresponding to the target frequency i for the last time, and use a time difference between the time Tᵢ and the current time Tₒ as the time interval ΔTᵢ corresponding to the target frequency i.

For example, as shown in FIG. 15, the UE determines five target frequencies in step S201, which are denoted as frequencies F₁ to F₅. A time at which the UE leaves the frequency F1 for the last time is T₁, a time at which the UE leaves the frequency F₂ for the last time is T₂, a time at which the UE leaves the frequency F₃ for the last time is T₃, a time at which the UE leaves the frequency F₄ for the last time is T₄, and a time at which the UE leaves the frequency F₅ for the last time is T₅. According to FIG. 15, if a sequence of the times T₁ to T₅ in a chronological order is T₃, T₁, T₅, T₂, and T₄, a sequence of time intervals ΔT₁ to ΔT₅ corresponding to the frequencies F₁ to F₅ in an ascending order is ΔT₄, ΔT₂, ΔT₅, ΔT₁, and ΔT₃. Therefore, a sequence of performing measurement on target frequencies is determined as F₄, F₂, F₅, F₁, and F₃.

In a second implementation, the UE can determine camping durations of the UE on all the first target frequencies, and then to determine, based on a descending order of the camping durations, a sequence of the first target frequencies on which the LTE cell is measured. During a specific implementation, for any target frequency i, the UE can determine a time Tᵢₙ at which the UE enters an LTE cell corresponding to the target frequency i and a time Tₒᵤₜ at which the UE leaves the LTE cell corresponding to the target frequency i, and use a time difference between the time Tᵢₙ and the time Tₒᵤₜ as a camping duration Sᵢ corresponding to the target frequency i. It should be noted herein that, if the UE camps on the LTE cell corresponding to the target frequency i for a plurality of times within the validity period of the target frequency i, the camping duration Si corresponding to the target frequency i can be accumulated.

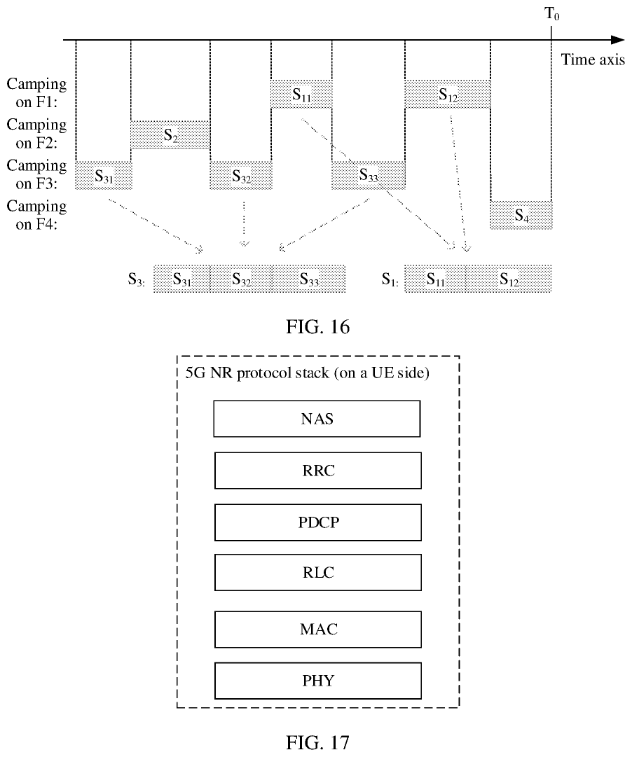

For example, as shown in FIG. 16, the UE determines four target frequencies in step S201, which are denoted as frequencies F₁ to F₄. In addition, before the current time Tₒ, the UE camps on the LTE cell at the frequency 1 twice for a period of S₁₁ and a period of S₁₂ respectively. In this case, the camping duration corresponding to the frequency 1 is S₁=S₁₁+S₁₂. The UE camps on the LTE cell of the frequency 2 once for a period of S₂, and the camping duration corresponding to the frequency 2 is S₂. The UE camps on the LTE cell at a frequency 3 for three times for a period of S₃₁, a period of S₃₂, and a period of S₃₃ respectively. The camping duration corresponding to the frequency 3 is S₃=S₃₁+S₃₂+S₃₃. The UE camps on the LTE cell at a frequency 4 once for a period of S₄, and the camping duration corresponding to the frequency 4 is S₄. According to FIG. 16, because S₃>S₁>S₂>S₄, the UE can determine that a sequence of performing measurement on the target frequencies is F₃, F₁, F₂, and F₄.

A third implementation: The UE can determine, based on an ascending order of distances between the locations of the LTE cell corresponding to the target frequencies and the current location of the UE, a sequence of the target frequencies on which the LTE cell is measured.

It can be understood that the foregoing manner where the UE determines the measurement sequence of the target frequencies is merely some, but not all, implementations that can be used in this embodiment of this application. A person skilled in the art can further determine the measurement sequence of the target frequencies in another manner under teaching of the technical concept of this embodiment of this application. These manners do not go beyond the protection scope of this embodiment of this application.

To facilitate the following description of a procedure where the UE reports the measurement report to the NG-RAN, in this embodiment of this application, a manner where the UE reports the cell measurement result from a physical layer PHY of a control plane (control plane, CP) protocol stack of the UE to the RRC layer is described herein.

FIG. 17 is a schematic diagram of a 5G NR control plane protocol stack on a UE side. The control plane protocol stack of 5G NR is almost the same as that of LTE on the UE side, including the physical layer PHY, a MAC layer, an RLC layer, a PDCP layer, an RRC layer, and a NAS layer. The physical layer is responsible for processing functions such as coding and decoding, modulation and demodulation, and multi-antenna mapping. The physical layer and hardware are closely related and works together, for example, working with a receiver to perform cell measurement on a target frequency. The MAC layer is responsible for processing a hybrid automatic repeat request (hybrid automatic repeat request, HARQ) and uplink and downlink scheduling. The RLC layer is responsible for segmentation, connection, retransmission, and sequential transmission of higher-layer data. The PDCP layer is used for providing a transmission service for a radio bearer. The RRC layer supports a key signaling protocol between UE and a base station. The NAS layer is used for processing information transmission between the UE and the core network, where transmitted content can be user plane information or control plane information.

According to a structure of the foregoing protocol stack, the UE performs cell measurement by using the physical layer and hardware such as the receiver. After completing the measurement, the UE needs to report a measurement result from the physical layer to the RRC layer, so that the measurement result is configured in a measurement report by using an RRC message and sent to the NG-RAN.

In a specific implementation, that the UE reports the measurement result from the physical layer to the RRC layer includes but is not limited to the following implementation.

In a first implementation, each time an LTE cell is measured, a physical layer of the UE reports a measurement result of the LTE cell. Generally, the physical layer of the UE can detect one or more LTE cells on each target frequency, or cannot detect an LTE cell. Then, when the UE detects LTE cells, the physical layer of the UE can measure the detected LTE cells separately, and each time the measurement of an LTE cell is completed, the UE reports a measurement result of the LTE cell. Therefore, for one target frequency, the UE may generate a plurality of actions of reporting measurement results from the physical layer to the RRC layer. In addition, it can be understood that, if no LTE cell is detected on a target frequency, the UE does not generate an action of reporting the measurement result from the physical layer to the RRC layer.

In a second implementation, each time the measurement is completed on each target frequency, the physical layer of the UE reports measurement results of all cells that are on the target frequency. In a specific implementation, if the physical layer of the UE detects LTE cells on the target frequency, the physical layer of the UE can measure the detected LTE cells separately, and report to the RRC layer the measurement results corresponding to the target frequency after all the LTE cells on the target frequency are measured. If no LTE cell is detected on a target frequency, the UE does not generate an action of reporting the measurement result from the physical layer to the RRC layer. Therefore, for one target frequency, the UE would generate at most one action of reporting the measurement result from the physical layer to the RRC layer.

Implementation 3: The UE reports measurement results of all the cells when the UE completes measurement on all target frequencies. During a specific implementation, regardless of whether the physical layer of the UE detects an LTE cell on a target frequency, the physical layer of the UE does not report a measurement result to the RRC layer for the target frequency or for the LTE cell. After physical layers of all UE complete the cell measurement on all target frequencies, the physical layers of the UE report all measurement results to the RRC layers. Therefore, the UE would generate at most one action of reporting the measurement result from the physical layer to the RRC layer during the cell measurement.

Further, as shown in FIG. 4, in the EPS FB procedure, if the NG-RAN does not have a capability of a VoNR service, when receiving a request that is sent by the 5GC and that is for setting up a dedicated bearer QoS flow, the NG-RAN sends a measurement request message to the UE. The measurement request can be, for example, an RRC connection reconfiguration message. The RRC connection reconfiguration message can include configuration of cell measurement, for example, a target frequency that requires measurement by the UE. In this embodiment of this application, to distinguish the target frequency determined automatically by the UE in step S201 from the target frequency delivered by the NG-RAN to the UE by using the configuration, the target frequency determined automatically by the UE in step S201 is referred to as a first target frequency in the following, and the target frequency delivered by the NG-RAN to the UE by using the configuration is referred to as a second target frequency.

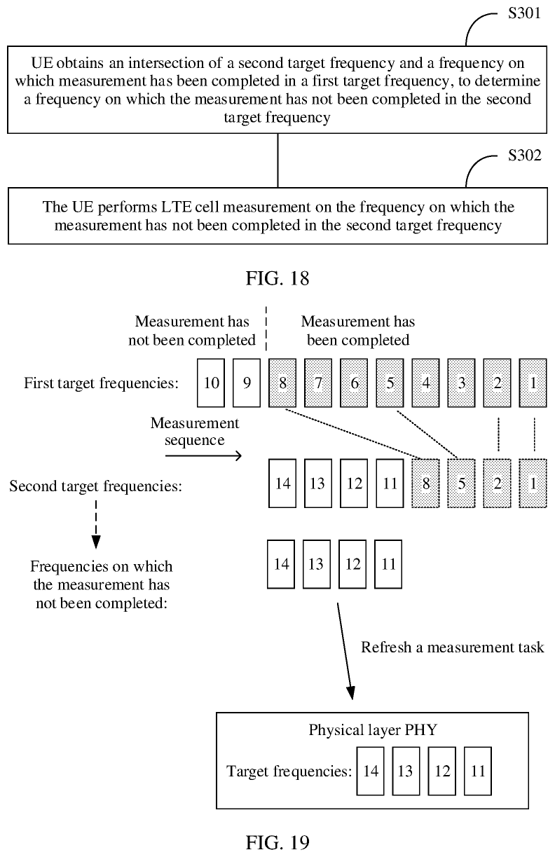

It can be understood that, in this embodiment of this application, the UE starts to perform cell measurement before the 5GC sends the request for setting up the dedicated bearer QoS flow to the NG-RAN (that is, before steps 2 and 3 in FIG. 4). Therefore, when the NG-RAN sends the measurement request to the UE, the UE has completed the cell measurement on some or all first target frequencies. In addition, considering that the second target frequency delivered by the NG-RAN to the UE by using the configuration may overlap the first target frequency, to prevent the UE from repeatedly measuring a same target frequency, as shown in FIG. 18, when receiving the second target frequency delivered by the NG-RAN, the UE can perform the following steps.

Step S301: The UE obtains an intersection of a second target frequency and a frequency on which the measurement has been completed in a first target frequency, to determine a frequency on which the measurement has not been completed in the second target frequency.

The following describes an implementation of step S301 by using an example with reference to FIG. 19.

As shown in FIG. 19, assuming that the UE determines 10 first target frequencies in step S201, which are denoted as frequencies 1 to 10 herein for ease of description. In addition, the UE further determines to perform cell measurement in a sequence of frequencies 1 to 10 shown in FIG. 11. When the UE performs the cell measurement on the 10 first target frequencies, the UE receives a measurement request message from the NG-RAN, where the measurement configuration includes eight second carrier frequencies. For example, the eight second carrier frequencies are respectively a frequency 1, a frequency 2, a frequency 5, a frequency 8, a frequency 11, a frequency 12, a frequency 13, and a frequency 14 shown in FIG. 11. It should be additionally noted herein that, numbers of frequencies shown in FIG. 19 are merely used to distinguish different frequencies, and do not represent real numbers of frequencies in the LTE system or the NR system. For example, the numbers do not represent an absolute radio-frequency channel number (absolute radio-frequency channel number, ARFCN) of a frequency.

Further, as shown in FIG. 19, assuming that the UE completes the cell measurement on the frequencies 1 to 8 when receiving the measurement request message from the NG-RAN. Then, an intersection of the frequencies 1 to 8 and the second target frequencies is obtained to determine that frequencies on which the measurement has been completed in the second target frequencies are frequencies 1, 2, 5, and 8 and that frequencies on which the measurement has not been completed in the second target frequencies are frequencies 11, 12, 13, and 14.

Step S302: The UE performs LTE cell measurement on the frequency on which the measurement has not been completed in the second target frequency.

The following continues to describe an implementation of step S302 by using an example with reference to FIG. 19.

As shown in FIG. 19, as an example, the UE can use the frequencies on which the measurement has not been completed in the second target frequencies, for example, frequencies 11, 12, 13, and 14, as measurement objects. A measurement task is refreshed for a physical layer, so that the physical layer starts to perform the cell measurement on the frequencies 11, 12, 13, and 14.

Optionally, the UE can determine the measurement sequence of the frequencies on which the measurement has not been completed in the second target frequencies in the following manners, but not limited to the following manners.

In a first implementation, a sequence that is of the frequencies on which the measurement has not been completed and that is in the measurement configuration delivered by the NG-RAN is used as a measurement sequence.

In a second implementation, the UE may determine a duration between a time at which the UE camps on each frequency on which the measurement has not been completed (which can be a time at which the UE leaves an LTE cell corresponding to the frequency for the last time) and a current time, and then determine a sequence of the frequencies on which the cell is measured in an ascending order of durations.

In a third implementation, the UE can determine durations when the UE has camped on all the target frequencies on which the measurement has not been completed, and then determine, based on a descending order of the camping durations, a sequence of the frequencies on which the cell is measured.

In a fourth implementation, the UE can determine, based on an ascending order of distances between locations of an LTE cell corresponding to the frequencies on which the measurement has not been completed and a current location of the UE, a sequence of the frequencies on which the cell is measured.

With reference to FIG. 4 and FIG. 18, it can be learned that, when the UE receives the measurement request message from the NG-RAN, if the UE has not performed the cell measurement before, the UE performs the cell measurement on all the second target frequencies delivered by the NG-RAN. Therefore, after receiving the measurement request message, the UE needs to perform the measurement on a large quantity of frequencies. A measurement time is longer. If the UE has performed the cell measurement before receiving the measurement request message, for example, step S101 has been performed, and then, when receiving the measurement request message from the NG-RAN, the UE can perform the cell measurement only on the frequencies on which the measurement has not been completed in the second target frequencies. The measurement time is shortened.

It should be additionally noted that the measurement request message delivered by the NG-RAN to the UE, for example, the RRC connection reconfiguration message, can include a measurement reporting configuration (reporting configuration). Generally, the measurement reporting configuration includes a measurement evaluation time timeToTrigger parameter, and a value of the parameter is an enumerated value. For example:
timeToTrigger::=ENUMERATED {
ms0, ms40, ms64, ms80, ms100, ms128, ms160, ms256, ms320, ms480, ms512, ms640, ms1024, ms1280, ms2560, ms5120}

ms0 corresponds to 0 ms, ms40 corresponds to 40 ms, ms80 corresponds to 80 ms, and so on. The foregoing enumerated parameters are used as an example. The UE can determine duration specifically indicated by the timeToTrigger parameter based on a value of a timeToTrigger parameter in the measurement reporting configuration (reporting configuration). For example, a timeToTrigger parameter 0 corresponds to ms0, that is, 0 millisecond, a timeToTrigger parameter 4 corresponds to ms100, that is, 100 milliseconds, a timeToTrigger parameter 8 corresponds to ms320, that is, 320 milliseconds, and so on.

The timeToTrigger parameter specifically indicates triggering reporting a measurement report to the NG-RAN when a measurement result of the UE constantly meets a reporting condition for a measurement report within the duration specified by the timeToTrigger parameter. Generally, when the RRC layer of the 5G NR control plane protocol stack of the UE receives a cell measurement result reported by the physical layer, a timer is started based on the timeToTrigger parameter. When the timer expires and the RRC layer does not receive a message indicating that the cell fails to meet the reporting condition for the measurement report, reporting of the measurement report to the NG-RAN is triggered.

The reporting condition for the measurement report can be configured by the NG-RAN in measurement reporting configuration (reporting configuration), or can be pre-configured in the UE. This is not limited in embodiments of this application. For example, that the reporting condition for the measurement report is met may include: The UE has measured a first LTE cell whose cell quality parameter meets a requirement (for example, RSRP or RSRQ is greater than a preset threshold).

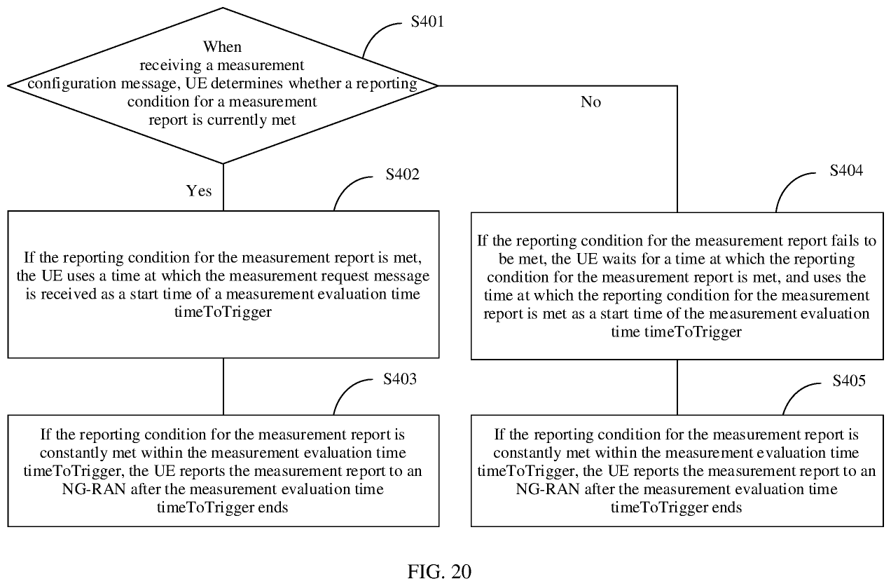

Further, based on the timeToTrigger parameter in the measurement request message of the NG-RAN, as shown in FIG. 20, the UE can specifically report the measurement report to the NG-RAN by using the following manner.

Step S401: When receiving a measurement request message, the UE determines whether a reporting condition for a measurement report is met currently.

In a specific implementation, when receiving the measurement request message, if the UE has measured the first LTE cell whose cell quality parameter meets the requirement, it indicates that the reporting condition for the measurement report is met currently, and if the UE has not measured the first LTE cell, it indicates that the reporting condition for the measurement report fails to be met currently.

Step S402: If the reporting condition for the measurement report is met, the UE uses a time at which the measurement request message is received as a start time of a measurement evaluation time timeToTrigger.

Step S403: If the reporting condition for the measurement report is constantly met within the measurement evaluation time timeToTrigger, the UE reports the measurement report to the NG-RAN after the measurement evaluation time timeToTrigger ends.

Alternatively, step S404: If the reporting condition for the measurement report fails to be met, the UE waits for a time at which the reporting condition for the measurement report is met, and uses the time at which the reporting condition for the measurement report is met as a start time of the measurement evaluation time timeToTrigger.

Step S405: If the reporting condition for the measurement report is constantly met within the measurement evaluation time timeToTrigger, the UE reports the measurement report to the NG-RAN after the measurement evaluation time timeToTrigger ends.

Content included in the measurement report can be specifically determined based on the measurement reporting configuration (reporting configuration). This is not limited in embodiments of this application. Generally, the measurement report can include a quality parameter, like RSRP, RSRQ, or a cell ID, that is of a target cell and that is obtained by performing measurement on the target frequency.

It should be additionally noted that, in this embodiment of this application, the manners where the UE performs the cell measurement and evaluates whether the measurement result meets a reporting condition are merely examples, and do not constitute a specific limitation on the UE. In specific practice, the UE can complete the foregoing steps with reference to the manner in this embodiment of this application, or can implement the foregoing steps based on a method formulated by a vendor to which the UE belongs. None of these goes beyond the protection scope of this embodiment of this application.

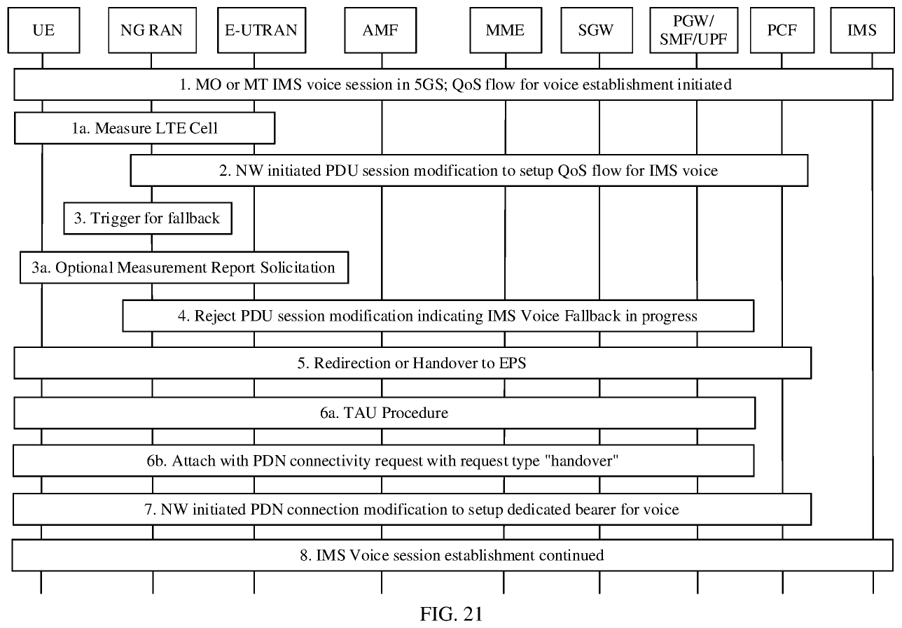

FIG. 21 is a flowchart of an EPS FB according to an embodiment of this application, which is obtained after modifying a technical solution of an example of this application based on FIG. 5, that is, based on a flowchart of an EPS FB described in a 3GPP technical specification TS 23.502. Step 1a in FIG. 21, that is, LTE cell measurement (Measure LTE Cell) corresponds to step S101 in this embodiment of this application. Step 3a in FIG. 21, that is, an optional measurement report solicitation (Optional Measurement Report Solicitation) corresponds to step S102 in this embodiment of this application.

With reference to FIG. 21, it can be learned that, in the technical solution provided in this embodiment of this application, an action of performing the LTE cell measurement by UE in an EPS FB procedure is advanced for being performed when the UE initiates an IMS call or receives an IMS call request. Therefore, when receiving a measurement request message from an NG-RAN, the UE can report a measurement report to the NG-RAN earlier based on a measurement result of the LTE cell measurement that has been completed in advance. Time for the NG-RAN to wait for the UE to report the measurement report is shortened. The objective of shortening the waiting time for setup of the EPS FB call is achieved. User experience is improved.

In the foregoing embodiments provided in this application, the solutions of the cell measurement method provided in this application are described from a perspective of the terminal device UE, and from a perspective of interaction between the UE, and the 5G access network NG-RAN, the 5G core network 5GC, the IMS system, or another network element. It can be understood that, to implement the foregoing functions, the terminal device UE includes corresponding hardware structures and/or software modules for performing the functions. A person skilled in the art should easily be aware that, in combination with units and algorithm steps of the examples described in embodiments disclosed in this specification, this application can be implemented by hardware or a combination of hardware and computer software. Whether a function is performed by hardware or hardware driven by computer software depends on particular applications and design constraints of the technical solutions. A person skilled in the art can use different methods to implement the described functions for each particular application, but it should not be considered that the implementation goes beyond the scope of this application.

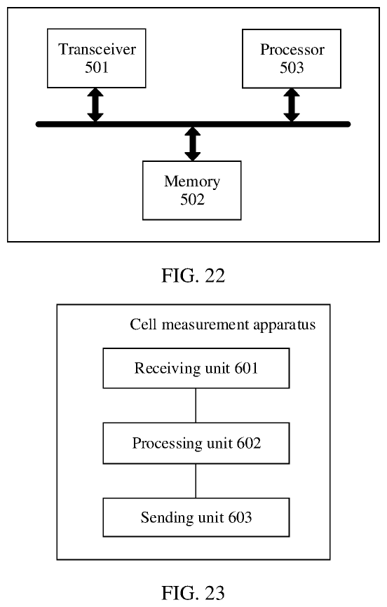

FIG. 22 is a schematic diagram of a structure of a cell measurement device according to an embodiment of this application.

In an embodiment, UE can implement a corresponding function by using a hardware apparatus shown in FIG. 22. As shown in FIG. 22, the cell measurement device can include a transceiver 501, a memory 502, and a processor 503.

In an implementation, the processor 503 can include one or more processing units. For example, the processor 503 can include an application processor, a modem processor, a graphics processor, an image signal processor, a controller, a video codec, a digital signal processor, a baseband processor, and/or a neural network processor. Different processing units can be independent components, or can be integrated into one or more processors. The memory 502 is coupled to the processor 503, and is configured to store various software programs and/or a plurality of groups of instructions. In some embodiments, the memory 502 can include a volatile memory and/or a non-volatile memory. The transceiver 501 can include, for example, a radio frequency circuit, a mobile communication module, a wireless communication module, and the like, and is configured to implement a wireless communication function of the UE.

In an embodiment, when the software program and/or the plurality of groups of instructions in the memory 502 are/is run by the processor 503, the UE is enabled to perform the following method steps: measuring a long term evolution LTE cell measurement when initiating an IP multimedia subsystem IMS voice call request or receiving an IMS voice call request; receiving a measurement request message sent by a 5G access network NG-RAN, where the measurement request message is sent when the NG-RAN determines, based on configuration of the NG-RAN, to enable IMS voice to fall back from a 5G network to a 4G network; and in response to the measurement request message, reporting a measurement report to the NG-RAN based on a measurement result of the LTE cell measurement.

In this way, the UE has measured the cell before receiving the measurement request message. Therefore, when receiving the measurement request message from the NG-RAN, the UE can report the measurement report to the NG-RAN earlier based on a measurement result of the LTE cell measurement that has been completed in advance. Time for the NG-RAN to wait for the UE to report the measurement report is shortened, and an objective of shortening a waiting time for setup of the EPS FB call is achieved.

Optionally, when the software program and/or the plurality of groups of instructions in the memory 502 are/is run by the processor 503, the UE is specifically configured to perform the following method steps: determining, based on information such as historical LTE frequency information, information about a new radio NR cell on which the terminal device currently camps, and/or a hardware capability of the UE, at least one first target frequency that is used for no-gap (no-gap) measurement; and measuring the LTE cell on the first target frequency. In this way, when performing the LTE cell measurement, the UE can continue to perform data communication with a network-side network element like the NG-RAN, to prevent an IMS call setup failure caused by a failure to receive a message from a network side.

Optionally, when the software program and/or the plurality of groups of instructions in the memory 502 are/is run by the processor 503, the UE is specifically enabled to perform the following method step: selecting, from historical LTE frequencies based on the hardware capability of the UE, all frequencies on which no-gap measurement can be performed to serve as first target frequencies.

Optionally, when the software program and/or the plurality of groups of instructions in the memory 502 are/is run by the processor 503, the UE is specifically enabled to perform the following method steps: selecting, from historical LTE frequencies based on the hardware capability of the UE, all frequencies on which the no-gap measurement can be performed; determining whether a quantity of all the frequencies on which the no-gap measurement can be performed is greater than a preset maximum quantity; when the quantity of all the frequencies on which the no-gap measurement can be performed is greater than the maximum quantity, selecting, from all the frequencies on which the no-gap measurement can be performed, frequencies whose quantity is less than or equal to the maximum quantity to serve as the first target frequencies; and when the quantity of all the frequencies on which the no-gap measurement can be performed is less than or equal to the maximum quantity, using all the frequencies on which the no-gap measurement can be performed as the first target frequencies.

Optionally, when the software program and/or the plurality of groups of instructions in the memory 502 are/is run by the processor 503, the UE is specifically enabled to perform the following method steps: selecting, from the historical LTE frequencies based on the hardware capability of the UE, all frequencies on which the no-gap measurement can be performed; and determining, based on a preset validity period, a first target frequency from all the frequencies on which the no-gap measurement can be performed. A time interval between a time at which the UE leaves the first target frequency for the last time and a current time is less than or equal to the validity period.

Optionally, when the software program and/or the plurality of groups of instructions in the memory 502 are/is run by the processor 503, the UE is specifically enabled to perform the following method steps: selecting, from historical LTE frequencies based on the hardware capability of the UE, all frequencies on which the no-gap measurement can be performed; and determining, based on a preset distance threshold, a first target frequency from all the frequencies on which the no-gap measurement can be performed. A distance between a location of an LTE cell corresponding to the first target frequency and a current location of the UE is less than or equal to the distance threshold.

Optionally, when the software program and/or the plurality of groups of instructions in the memory 502 are/is run by the processor 503, the UE is specifically enabled to perform the following method step: determining a current location based on satellite positioning information, wireless fidelity Wi-Fi information, base station positioning information, and/or a currently accessed NR cell.

Optionally, when the software program and/or the plurality of groups of instructions in the memory 502 are/is run by the processor 503, the UE is further enabled to perform the following method steps: determining, based on an ascending order of time interval between times at which the UE leaves the first target frequencies for the last time and a current time, a sequence of the first target frequencies on which the LTE cell is measured.

Optionally, when the software program and/or the plurality of groups of instructions in the memory 502 are/is run by the processor 503, the UE is further enabled to perform the following method steps: determining camping duration of the UE on each first target frequency; and determining, based on a descending order of camping duration, a sequence of the first target frequencies on which the LTE cell is measured.

Optionally, the measurement request message includes at least one second target frequency. When the software program and/or the plurality of groups of instructions in the memory 502 are/is run by the processor 503, the UE is further enabled to implement the following method steps: in response to the measurement request message, obtaining an intersection of the second target frequency and a frequency on which the measurement has been completed in the first target frequencies, to determine a frequency on which the measurement has not been completed in the second target frequencies; and measuring the LTE cell on the frequency on which the measurement has not been completed in the second target frequency. In this way, when receiving the measurement request message from the NG-RAN, the UE can perform cell measurement only on a frequency on which measurement has not been completed in the second target frequency. Therefore, a measurement time is shortened, and the time for the NG-RAN to wait for the UE to report the measurement report is thus shortened. The objective of shortening the waiting time for setup of the EPS FB call is finally achieved.

Optionally, when the software program and/or the plurality of groups of instructions in the memory 502 are/is run by the processor 503, the UE is specifically enabled to perform the following method steps: When receiving a measurement request message, the UE determines whether a reporting condition for a measurement report is met currently. If the reporting condition for the measurement report is constantly met within a measurement evaluation time timeToTrigger, the UE reports the measurement report to the NG-RAN after the measurement evaluation time timeToTrigger ends. Or, if the reporting condition for the measurement report fails to be met, the UE waits for a time at which the reporting condition for the measurement report is met, and uses the time at which the reporting condition for the measurement report is met as a start time of the measurement evaluation time timeToTrigger. Then, if the reporting condition for the measurement report is constantly met within the measurement evaluation time timeToTrigger, the UE reports the measurement report to the NG-RAN after the measurement evaluation time timeToTrigger ends. In this way, if the measurement report meets the reporting condition when the UE receives the measurement request message, the UE can use the time at which the UE receives the measurement request message as a start time for calculating the measurement evaluation time timeToTrigger. Therefore, the UE can complete waiting for the timeToTrigger earlier and report the measurement report to the NG-RAN. The time for the NG-RAN to wait for the UE to report the measurement report is shortened, and the objective of shortening the waiting time for setup of the EPS FB call is achieved.

In addition, in some embodiments, the UE can implement a corresponding function by using a software module. As shown in FIG. 23, a cell measurement device configured to implement a function of behavior of the terminal device UE includes a receiving unit 601, a processing unit 602, and a sending unit 603. The processing unit 602 is configured to perform LTE cell measurement when the UE initiates an IMS call or receives an IMS call request. The receiving unit 601 is configured to receive an LTE cell signal during the LTE cell measurement, and to receive a measurement request message from an NG-RAN. The sending unit 603 is configured to, when the receiving unit 601 receives the measurement request message from the NG-RAN, report a measurement report to the NG-RAN based on a measurement result of the LTE cell measurement.

In this way, the UE has measured the cell before receiving the measurement request message. Therefore, when receiving the measurement request message from the NG-RAN, the UE can report the measurement report to the NG-RAN earlier based on a measurement result of LTE cell measurement that has been completed in advance. Time for the NG-RAN to wait for the UE to report the measurement report is shortened, and an objective of shortening a waiting time for setup of the EPS FB call is achieved.

Optionally, the processing unit 602 is configured to determine, based on information such as historical LTE frequency (carrier frequency) information, information about an NR cell on which the UE currently camps, and a hardware capability of the UE, a target frequency that is used for no-gap (no-gap) measurement. The processing unit 602 is further configured to perform the LTE cell measurement on the target frequency. In this way, when performing the LTE cell measurement, the UE can continue to perform data communication with a network-side network element like an NG-RAN, to prevent an IMS call setup failure caused by a failure to receive a message from a network side.

Optionally, the processing unit 602 is configured to, when the receiving unit 601 receives the second target frequency delivered by the NG-RAN, obtain an intersection of the second target frequency and a frequency on which the measurement has been completed in the first target frequencies, to determine a frequency on which the measurement has not been completed in the second target frequency. The processing unit 602 is further configured to measure the LTE cell on the frequency on which the measurement has not been completed in the second target frequency. In this way, when receiving the measurement request message from the NG-RAN, the UE can perform cell measurement on only the frequency on which measurement has not been completed in the second target frequency. Therefore, a measurement time is shortened, and the time for the NG-RAN to wait for the UE to report the measurement report is thus shortened. The objective of shortening the waiting time for setup of the EPS FB call is finally achieved.

Optionally, the processing unit 602 is configured to, when the receiving unit 601 receives the measurement request message, determine whether a reporting condition for a measurement report is met currently. The processing unit 602 is configured to, if the reporting condition for the measurement report is met, use a time at which the measurement request message is received as a start time of a measurement evaluation time timeToTrigger. Alternatively, the processing unit 602 is further configured to, if the fails to meet the reporting condition for the measurement report, the UE waits for a time at which the reporting condition for the measurement report is met, and uses the time at which the reporting condition for the measurement report is met as a start time of the measurement evaluation time timeToTrigger. The sending unit 603 is configured to, if the reporting condition for the measurement report is constantly met within the measurement evaluation time timeToTrigger, the UE reports the measurement report to the NG-RAN after the measurement evaluation time timeToTrigger ends.

For technical features that are not disclosed in the apparatus embodiments of this application, refer to the method embodiments of this application. Details are not described herein again.

An embodiment of this application further provides a computer storage medium. The computer storage medium stores computer instructions. When the computer instructions run on a computer, the computer is enabled to perform the method according to the foregoing aspects.

An embodiment of this application further provides a computer program product including instructions. When the instructions run on a computer, the computer is enabled to perform the method according to the foregoing aspects.

An example of this application further provides a network system, including a terminal device UE, a 5G access network NG-RAN, a 5G core network 5GC, a 4G access network E-UTRAN, a 4G core network EPC, and an IMS system. The network system is configured to support the UE in implementing the methods according to the foregoing aspects.

This application further provides a chip system. The chip system includes a processor for supporting the foregoing apparatus or device in implementing a function in the foregoing aspects, for example, generating or processing information in the foregoing method. In a possible design, the chip system further includes a memory for storing program instructions and data that are necessary for the foregoing apparatus or device. The chip system can include a chip, or can include a chip and another discrete component.

The objectives, technical solutions, and benefits of the present invention are further described in detail in the foregoing specific embodiments. It should be understood that the foregoing descriptions are merely specific embodiments of the present invention, but are not intended to limit the protection scope of the present invention. Any modification, equivalent replacement, or improvement made within the spirit and principle of the present invention shall fall within the protection scope of the present invention.

1-31. (canceled)

32. A terminal device, comprising a transceiver, a non-transitory memory, and a processor, wherein the memory stores computer program instructions, and when the program instructions are executed by the processor, the terminal device is caused to perform:
measuring a long term evolution (LTE) cell when an IP multimedia subsystem (IMS) voice call request is initiated or an IMS voice call request is received by the terminal device, measuring the LTE cell generating a first measurement result;
receiving a measurement request message sent by an access network device, wherein the measurement request message is sent by the access network device when determining to enable IMS voice to fall back to a 4G network from a 5G network, and the measurement request message requests for measuring the LTE cell; and
in response to the measurement request message, reporting a measurement report to the access network device based on at least the first measurement result of the LTE cell.

33. The terminal device according to claim 32, wherein when the program instructions are executed by the processor, the terminal device is further caused to perform:
determining at least one first target frequency that is usable for no-gap measurement, based on historical LTE frequency information, information about a new radio (NR) cell on which the terminal device currently camps, and/or a hardware capability of the terminal device; and
measuring the LTE cell on the at least one first target frequency.

34. The terminal device according to claim 33, wherein when the program instructions are executed by the processor, the terminal device is further caused to perform:
selecting, from historical LTE frequencies based on the hardware capability of the terminal device, frequencies on which the no-gap measurement is performable as first target frequencies.

35. The terminal device according to claim 33, wherein when the program instructions are executed by the processor, the terminal device is further caused to perform:
selecting, from historical LTE frequencies based on the hardware capability of the terminal device, frequencies on which the no-gap measurement is performable, and determining whether a first quantity of the frequencies on which the no-gap measurement is performable is greater than a preset maximum quantity;
when the first quantity of the frequencies on which the no-gap measurement is performable is greater than the preset maximum quantity, selecting, from the frequencies on which the no-gap measurement is performable, a second quantity of frequencies as first target frequencies, the second quantity being less than or equal to the preset maximum quantity; and
when the first quantity of the frequencies on which the no-gap measurement is performable is less than or equal to the preset maximum quantity, using all the frequencies on which the no-gap measurement is performable as the first target frequencies.

36. The terminal device according to claim 33, wherein when the program instructions are executed by the processor, the terminal device is further caused to perform:
selecting, from historical LTE frequencies based on the hardware capability of the terminal device, frequencies on which the no-gap measurement is performable, and determining, based on a preset validity period, a first target frequency of the at least one first target frequency from the frequencies on which the no-gap measurement is performable, wherein a time interval between a time at which the terminal device leaves a cell corresponding to the first target frequency for the last time and a current time is less than or equal to the preset validity period.

37. The terminal device according to claim 33, wherein when the program instructions are executed by the processor, the terminal device is further caused to:
selecting, from historical LTE frequencies based on the hardware capability of the terminal device, frequencies on which the no-gap measurement is performable, and determining, based on a preset distance threshold, a first target frequency of the at least one first target frequency from the frequencies on which the no-gap measurement is performable, wherein a distance between a location of an LTE cell corresponding to the first target frequency and a current location of the terminal device is less than or equal to the preset distance threshold.

38. The terminal device according to claim 37, wherein when the program instructions are executed by the processor, the terminal device is further caused to perform:
determining the current location based on satellite positioning information, wireless fidelity (Wi-Fi) information, base station positioning information, and/or a currently accessed NR cell.

39. The terminal device according to claim 33, wherein when the program instructions are executed by the processor, the terminal device is further caused to perform:
determining, based on an ascending order of time intervals between times at which the terminal device leaves cell(s) corresponding to the at least one first target frequency for the last time and a current time, a sequence of the at least one first target frequency on which the LTE cell is measured.

40. The terminal device according to claim 33, wherein when the program instructions are executed by the processor, the terminal device is further caused to perform:
determining camping duration(s) of the terminal device on the at least one first target frequency, and determining, based on a descending order of the camping duration(s), a sequence of the at least one first target frequency on which the LTE cell is measured.

41. The terminal device according to claim 33, wherein when the program instructions are executed by the processor, the terminal device is further caused to perform:
determining, based on an ascending order of distances between locations of LTE cell(s) corresponding to the at least one first target frequency and a current location of the terminal device, a sequence of the at least one first target frequency on which the LTE cell is measured.

42. The terminal device according to claim 33, wherein the measurement request message comprises at least one second target frequency, and when the program instructions are executed by the processor, the terminal device is further caused to perform:
in response to the measurement request message, obtaining an intersection of the at least one second target frequency and a first frequency on which a measurement has been completed in the at least one first target frequency, to determine a second frequency on which a measurement has not been completed in the at least one second target frequency; and
measuring the LTE cell on the second frequency in the at least one second target frequency.

43. The terminal device according to claim 32, wherein the measurement request message comprises a measurement evaluation time, and when the program instructions are executed by the processor, the terminal device is further caused to perform:
in response to the measurement request message, determining whether a measurement result meets a reporting condition for the measurement report;
using a time at which the measurement request message is received as a start time of the measurement evaluation time when the measurement result meets the reporting condition for the measurement report; and
when the measurement result fails to meet the reporting condition for the measurement report, waiting until a time at which the measurement result meets the reporting condition for the measurement report, and using a time at which the measurement result meets the reporting condition for the measurement report as a start time of the measurement evaluation time.

44. The terminal device according to claim 43, wherein when the program instructions are executed by the processor, the terminal device is further caused to perform:
when the measurement result constantly meets the reporting condition for the measurement report within the measurement evaluation time, reporting the measurement report to the access network device when the measurement evaluation time ends.

45. The terminal device according to claim 32, wherein when the program instructions are executed by the processor, the terminal device is further caused to perform:
when the terminal device is configured to support fallback of the IMS voice to the 4G network from the 5G network, determining whether to fall back to the 4G network, based on capability of the terminal device, an indication of an access and mobility management function (AMF) of a core network, a network configuration, and/or a radio condition.

46. The terminal device according to claim 32, wherein the access network device is a 5G access network NG-RAN.

47. A network system, wherein the network system comprises an access network device and a user equipment (UE);
the UE is configured to measure a long term evolution (LTE) cell when initiating an IP multimedia subsystem (IMS) voice call request or receiving an IMS voice call request, measuring the LTE cell generating a first measurement result;
the access network device is configured to send a measurement request message to the UE when determining to enable IMS voice to fall back to a 4G network from a 5G network; and
the UE is further configured to, in response to the measurement request message, report a measurement report to the access network device based on at least the first measurement result of the LTE cell.

48. The network system according to claim 47, wherein the UE is further configured to:
determine at least one first target frequency that is usable for no-gap measurement, based on historical LTE frequency information, information about a new radio (NR) cell on which the UE currently camps, and/or a hardware capability of the UE; and
measure the LTE cell on the at least one first target frequency.

49. The network system according to claim 48, wherein the UE is further configured to select, from historical LTE frequencies based on the hardware capability of the UE, frequencies on which the no-gap measurement is performable as first target frequencies.

50. The network system according to claim 48, wherein the UE is further configured to:
select, from historical LTE frequencies based on the hardware capability of the UE, frequencies on which the no-gap measurement is performable, and determine whether a first quantity of the frequencies on which the no-gap measurement is performable is greater than a preset maximum quantity;
when the first quantity of the frequencies on which the no-gap measurement is performable is greater than the preset maximum quantity, select, from the frequencies on which the no-gap measurement is performable, a second quantity of frequencies as first target frequencies, the second quantity being less than or equal to the preset maximum quantity; and
when the first quantity of all the frequencies on which the no-gap measurement is performable is less than or equal to the preset maximum quantity, use all the frequencies on which the no-gap measurement is performable as the first target frequencies.

51. The network system according to claim 48, wherein the UE is further configured to:
select, from historical LTE frequencies based on the hardware capability of the UE, frequencies on which the no-gap measurement is performable; and
determine, based on a preset validity period, a first target frequency of the at least one first target frequency from the frequencies on which the no-gap measurement is performable, wherein a time interval between a time at which the UE leaves a cell corresponding to the first target frequency for the last time and a current time is less than or equal to the preset validity period.
